(19) United States
(12) Patent Application Publication
(10) Pub. No.: US 2025/0025834 A1
(43) Pub. Date: Jan. 23, 2025

(54) METHODS FOR ISOLATION AND CONCENTRATION OF EXOSOMES AND OTHER EXTRACELLULAR VESICLES

(71) Applicant: INNOVAPREP LLC, Drexel, MO (US)

(72) Inventors: Andrew E. Page, Smithton, MO (US); David Goad, Stillwater, OK (US); David S. Alburty, Drexel, MO (US)

(21) Appl. No.: 18/778,834

(22) Filed: Jul. 19, 2024

Related U.S. Application Data
(60) Provisional application No. 63/527,793, filed on Jul. 19, 2023.

(51) Int. Cl. B01D 61/14

(52) U.S. Cl. CPC B01D 61/147; B01D 2313/205

(57) ABSTRACT

Highly efficient and rapid filtration-based methods for isolation and concentration of exosomes and extracellular vesicles from biological fluids, including urine, which utilize pretreatment, prefiltration, wash steps and isolation and concentration using the concentrating pipette are disclosed.

This patent application claims priority to U.S. Provisional Patent Application Ser. No. 63/527,793, filed Jul. 19, 2023; the contents of which are hereby incorporated by reference herein in their entirety into this disclosure.

### BACKGROUND OF THE SUBJECT DISCLOSURE

### Field of the Subject Disclosure

The subject disclosure relates generally to the fields of invitro diagnostics and therapeutics. More particularly, the subject disclosure relates to methods, utilizing a liquid-to-liquid biological particle concentrator with a disposable fluid path, for isolation and concentration of exosomes for increasing the concentration and improving the quality of therapeutic products and invitro diagnostic samples, and enhancing the sensitivity of subsequent invitro diagnostic analysis methods.

### Background of the Subject Disclosure

Exosomes are small extracellular vesicles (EVs), typically ranging from 30 to 150 nm in diameter. Larger EVs and apoptotic bodies can be from 150 nm to 2 microns in diameter. Exosomes and EVs are released by cells and found in various bodily fluids, including blood, urine, and saliva. Ultimately, these and other bodily fluids are discharged into the environment, for example into wastewater or natural waters, swimming pools, and experimental and farmed animal tanks (aquaria). They carry diverse molecular constituents of their cell of origin, including proteins, lipids, and nucleic acids, and have been implicated in a range of physiological processes and diseases, such as cancer, cardiovascular disease, and neurodegenerative disorders. Exosomes and EVs have gained significant attention in biomedical research due to their potential applications in diagnostics, therapeutics, and drug delivery. Isolation and concentration of exosomes from biological fluids or cell culture media are crucial steps for downstream analysis and utilization. Isolation and concentration from wastewater and aquaria tanks are examples where EVs generated by populations of humans or animals may be studied.

Existing technologies for exosome isolation and concentration are often labor-intensive, time-consuming, and suffer from low yield and purity issues. There is a need for improved technologies that can effectively concentrate exosomes from various biological and environmental fluids in a rapid, efficient, and reliable manner.

Existing technologies for exosome isolation and concentration generally fall into one of 7 categories, including ultracentrifugation, density gradient centrifugation, size exclusion chromatography, immunocapture, microfluidic, precipitation, and ultrafiltration. A brief description of each of these categories is provided in the following paragraphs. The descriptions, advantages, and disadvantages for each are generally described in relation to their use for isolation of urinary exosomes. Many of the advantages and disadvantages related to isolation from urine also apply to isolation of exosomes from other biological fluids, but some additional information is also provided specific to other fluid types. Other clinical fluids may be processed using the same methods described herein, as will be understood by those skilled in the art. Additional clinical fluid samples that may be processed using these described methods, as will be well understood by those skilled in the art, include, but are not limited to: whole blood, plasma, serum, sputum, saliva, pleural fluid, peritoneal fluid, synovia fluid, amniotic fluid, seminal fluid, bile, breast milk, gastric juice, sweat, ascitic fluid, pericardial fluid, and cerebrospinal fluid. Certain modifications made to the methods of prefiltration followed by concentration may be made to enable processing of these fluids, as will be well understood by those skilled in the art.

Ultracentrifugation: Ultracentrifugation is the most commonly used method for exosome isolation. It involves a series of differential and density gradient centrifugation steps. Initially, a low-speed centrifugation is performed to remove cells and large debris, followed by high-speed centrifugation to pellet the exosomes. Density gradient centrifugation can then be employed to separate exosomes from other contaminants based on their buoyant density. Ultracentrifugation offers high purity and scalability but is time-consuming and requires specialized equipment.

Ultracentrifugation, while a widely used method for exosome isolation, presents certain deficiencies when applied to isolating exosomes from urine samples. Aside from technical difficulties, ultracentrifugation exhibits several logistical and cost deficiencies that should be acknowledged. Of significant concern, the methods associated with ultracentrifugation are time-consuming and labor-intensive processes, involving multiple centrifugation steps and long run times, which may limit its suitability for high-throughput applications. Ultracentrifugation techniques are tedious in that they are normally made up of multiple steps each requiring a high level of concentration from the operator. The potential for human error is high due to the tedious nature and automation of these techniques is difficult and costly. Additionally, the cost and accessibility of the specialized equipment required for ultracentrifugation may hinder its widespread adoption, particularly in resource-limited settings.

Other deficiencies related to the use of ultracentrifugation for exosomes isolation are of concern. Firstly, urine contains a high concentration of soluble proteins and salts, which can interfere with the isolation process and result in co-pelleting of contaminants along with exosomes. These contaminants can include urinary sediment, lipoproteins, and protein aggregates, leading to impure exosome preparations. The presence of high levels of urea and other solutes can also affect the stability and integrity of exosomes during the centrifugation process.

Secondly, urine samples typically have a low exosome concentration, making it challenging to achieve a sufficient yield of exosomes using ultracentrifugation. The dilute nature of urine requires larger sample volumes to isolate an adequate quantity of exosomes, increasing the processing time and effort involved. This limitation can be particularly problematic when working with limited volumes of urine, such as samples obtained from pediatric patients or longitudinal studies.

Thirdly, the long centrifugation times required for ultracentrifugation may lead to exosome aggregation or degradation, further compromising the integrity and functionality of the isolated exosomes. The high gravitational forces can induce structural alterations in exosomes and result in the loss of specific surface markers or the disruption of their cargo content. These changes may have implications for downstream applications, such as biomarker analysis or functional studies, where the intactness of exosomes is critical.

In conclusion, while ultracentrifugation is a commonly employed method for exosome isolation, its application to urine samples faces several deficiencies. These include the co-pelleting of contaminants, low exosome concentration, potential aggregation or degradation of exosomes, and the need for larger sample volumes. Alternative isolation methods or modifications to the ultracentrifugation protocol are necessary to overcome these deficiencies and ensure the extraction of pure and intact exosomes from urine for further analysis and clinical applications.

Density Gradient Centrifugation: Density gradient centrifugation is often used as an adjunct technique in combination with ultracentrifugation or other isolation methods. It involves layering a sample onto a density gradient medium (e.g., sucrose or iodixanol) and subjecting it to centrifugation. Exosomes migrate through the gradient, forming distinct bands or fractions that can be collected and further purified. Density gradient centrifugation enhances exosome purity and helps separate them from lipoproteins and protein aggregates.

When utilizing density gradient centrifugation for exosome isolation from urine samples, certain deficiencies should be considered. Firstly, urine contains a complex mixture of particles and contaminants, such as cellular debris, lipoproteins, and protein aggregates. While density gradient centrifugation aims to separate exosomes based on their buoyant density, it may not provide sufficient resolution to completely eliminate these contaminants. As a result, the isolated exosome fraction may still contain impurities, potentially affecting downstream analysis and applications.

Secondly, the low exosome concentration in urine poses a challenge for density gradient centrifugation. The limited number of exosomes in urine samples can lead to low yields during the isolation process, requiring larger starting volumes to obtain a sufficient quantity of exosomes. This can be particularly problematic when working with pediatric or small-volume samples, where the available starting material is limited.

Thirdly, the extended duration of density gradient centrifugation can have detrimental effects on exosomes. Prolonged centrifugation times may cause exosome aggregation or degradation, leading to changes in their structure, surface markers, and cargo content. These alterations can impact the functionality and integrity of the isolated exosomes, making them less suitable for downstream applications that rely on intact exosomes.

In summary, density gradient centrifugation for exosome isolation from urine samples has its deficiencies. These include incomplete removal of contaminants, low exosome concentration resulting in low yields, and potential damage or alteration of exosomes during the extended centrifugation process. Alternative methods or modifications to the density gradient centrifugation protocol are required to address these deficiencies and improve the purity, yield, and integrity of exosomes isolated from urine for further research and clinical applications.

Size Exclusion Chromatography (SEC): SEC separates exosomes based on their size and molecular weight. The technique involves passing the sample through a column packed with porous beads. Larger particles, such as cells and debris, elute earlier, while exosomes elute later due to their smaller size. SEC offers relatively simple and rapid isolation, but it may not provide optimal purity, as other small particles, such as protein aggregates, can co-elute with exosomes.

When employing size exclusion chromatography (SEC) for exosome isolation from urine samples, several deficiencies should be taken into account. Firstly, urine contains a complex mixture of particles and biomolecules, including proteins, lipoproteins, and cellular debris. SEC separates particles based on their size, but it may not provide sufficient resolution to completely separate exosomes from these contaminants. As a result, there is a risk of co-elution of impurities with the exosome fraction, leading to impure exosome preparations that may hinder downstream analysis and applications.

Secondly, the low exosome concentration in urine poses a challenge for SEC. The limited abundance of exosomes in urine samples can result in low yields during the isolation process. To obtain a sufficient quantity of exosomes, larger starting volumes are often required, which may not be feasible for small or limited-volume samples. This limitation can affect the overall efficiency and practicality of exosome isolation using SEC.

Thirdly, the use of SEC alone may not adequately preserve the integrity and functionality of exosomes. The process of passing exosome-containing urine samples through the chromatography column, coupled with potential interactions with the stationary phase, can lead to alterations in the size, structure, and surface properties of exosomes. These changes may impact the biological activity and cargo content of the isolated exosomes, which can be problematic for downstream applications that rely on the intact and functional nature of exosomes.

In summary, the use of size exclusion chromatography for exosome isolation from urine samples has its deficiencies. These include potential co-elution of contaminants, low exosome concentration resulting in low yields, and potential alterations to the structure and functionality of exosomes during the chromatographic process. Complementary or alternative methods may need to be considered to overcome these deficiencies and improve the purity, yield, and preservation of exosomes from urine for further research and clinical applications.

Immunocapture: Immunocapture methods utilize specific antibodies targeting exosome surface markers to selectively isolate exosomes. Antibodies are immobilized on solid supports, such as magnetic beads or microplates, which bind and capture exosomes from the sample. The captured exosomes can be eluted for downstream analysis. Immunocapture techniques provide high specificity but may be limited by the availability of suitable antibodies and potential alterations in exosome properties during the binding process.

When utilizing immunocapture for exosome isolation from urine samples, several deficiencies should be considered. Firstly, urine contains a complex mixture of particles, proteins, and cellular debris. While immunocapture relies on specific antibody-antigen interactions to selectively capture exosomes, there is a potential for non-specific binding of antibodies to other components present in urine. This can result in co-isolation of non-exosomal particles and contaminants, leading to impure exosome preparations that may affect downstream analysis and applications.

Secondly, the low exosome concentration in urine poses a challenge for immunocapture. The limited abundance of exosomes in urine samples can result in low yields during the isolation process. In order to obtain a sufficient quantity of exosomes, larger starting volumes may be required, which may not be practical or feasible, especially for samples with limited volumes or pediatric samples. This limitation can impact the overall efficiency and feasibility of exosome isolation using immunocapture.

Thirdly, the choice and specificity of antibodies used for immunocapture are crucial. Different exosome populations in urine may express distinct surface markers, necessitating the use of multiple antibodies for capturing diverse exosome subpopulations. Ensuring the specificity and efficiency of the chosen antibodies is essential to avoid potential cross-reactivity and obtain a highly pure exosome fraction.

In summary, the use of immunocapture for exosome isolation from urine samples has its deficiencies. These include the potential for non-specific binding and co-isolation of contaminants, low exosome concentration resulting in low yields, and the need for careful selection and validation of antibodies for specific exosome subpopulations. Considering alternative methods or combining immunocapture with complementary techniques may be necessary to address these deficiencies and improve the purity, yield, and specificity of exosomes isolated from urine for further research and clinical applications.

Microfluidics: Microfluidic-based platforms employ microscale channels and integrated functional elements to capture and isolate exosomes. These devices can utilize size-based filtration, immunocapture, or acoustic methods for exosome separation. Microfluidic techniques offer advantages such as reduced sample volume requirements, increased sensitivity, and potential for automation. However, challenges remain in standardization, scalability, and compatibility with downstream applications.

Microfluidic approaches for exosome isolation from urine samples offer several advantages, but they also have certain deficiencies that should be considered. Firstly, urine contains a complex mixture of particles, proteins, and cellular debris, making it challenging to selectively isolate exosomes using microfluidic devices. While microfluidic platforms can incorporate specific capture agents, such as antibodies or aptamers, the potential for non-specific binding and co-isolation of contaminants remains a concern. The presence of high levels of soluble proteins and salts in urine can further complicate the isolation process and impact the purity of the isolated exosome fraction.

Secondly, the low exosome concentration in urine poses a limitation for microfluidic approaches. The diluted nature of urine necessitates larger sample volumes or concentration steps to obtain sufficient exosomes for downstream analysis. However, concentration steps can introduce additional challenges, such as the risk of clogging or fouling of microfluidic channels, affecting the efficiency and reproducibility of exosome isolation.

Thirdly, the scalability of microfluidic devices for processing larger volumes of urine is still a challenge. While microfluidics offer the potential for high-throughput and parallel processing, scaling up the device design and operation to handle larger urine volumes is not straightforward. Achieving consistent and reliable isolation of exosomes from bulk urine samples remains a technical hurdle that needs to be overcome.

In summary, while microfluidic approaches offer promising advantages for exosome isolation from urine, they also have deficiencies to be addressed. These include potential non-specific binding and co-isolation of contaminants, the low concentration of exosomes in urine requiring concentration steps, and challenges in scaling up for processing larger urine volumes. Further advancements in microfluidic device design, surface modification strategies, and integration with other isolation techniques are necessary to improve the selectivity, efficiency, and scalability of microfluidic-based exosome isolation from urine samples for various research and clinical applications.

Precipitation: Exosome precipitation methods rely on the addition of reagents, such as polyethylene glycol (PEG) or other polymers, to induce exosome aggregation and subsequent precipitation. After precipitation, exosomes can be collected by centrifugation or filtration. Precipitation techniques are relatively simple and time-efficient, but they may result in co-precipitation of other particles and contaminants, affecting purity and yield.

The use of precipitation methods for exosome isolation from urine samples has certain deficiencies that should be considered. Firstly, urine contains a complex mixture of particles, proteins, and salts, which can interfere with the precipitation process. The precipitation reagents commonly used, such as polyethylene glycol (PEG) or ExoQuick™, may also co-precipitate contaminants along with exosomes, leading to impure exosome preparations. The presence of high levels of soluble proteins and salts in urine can further complicate the precipitation process and impact the purity of the isolated exosome fraction.

Secondly, the low exosome concentration in urine poses a challenge for precipitation-based methods. The dilute nature of urine requires larger sample volumes to obtain a sufficient quantity of exosomes. This can be problematic when working with limited or precious urine samples, as it may be difficult to obtain the required volume for effective precipitation.

Thirdly, precipitation methods may not preserve the integrity and functionality of exosomes. The harsh conditions and chemical agents involved in the precipitation process can potentially affect the structure, surface markers, and cargo content of exosomes. This can impact their functionality and suitability for downstream applications, such as biomarker analysis or functional assays.

In summary, the use of precipitation methods for exosome isolation from urine samples has deficiencies that need to be considered. These include the potential co-precipitation of contaminants, the low exosome concentration requiring larger sample volumes, and the potential impact on exosome integrity and functionality. Further optimization of precipitation protocols and the development of additional purification steps may be necessary to improve the purity, yield, and preservation of exosomes isolated from urine for various research and clinical applications.

Ultrafiltration: Ultrafiltration is a size-based filtration method that utilizes membranes with defined pore sizes to concentrate exosomes. The technique involves passing the sample through a membrane that retains particles above a specific size threshold while allowing smaller molecules and exosomes to pass through. By selecting an appropriate molecular weight cutoff (MWCO) for the membrane, larger contaminants, such as proteins and lipoproteins, can be effectively removed, while exosomes are concentrated in the retentate.

Ultrafiltration can be performed using various filtration setups, including centrifugal filters, stirred cell systems, or tangential flow filtration (TFF). Centrifugal filters are commonly used for small-scale applications, where the sample is loaded into the filter unit and subjected to centrifugation to generate pressure across the membrane. This pressure drives the filtrate (containing smaller particles and exosomes) through the membrane, while larger particles are retained.

Stirred cell systems employ a pressure-driven filtration approach. The sample is continuously circulated through the filtration unit, and pressure is applied to force the filtrate across the membrane. The retentate, enriched with exosomes, remains in the filtration chamber.

Tangential flow filtration (TFF) is a continuous flow method that offers higher processing volumes. The sample flows parallel to the membrane surface, and a cross-flow is generated across the membrane, minimizing filter clogging. The retentate containing exosomes is collected, while the filtrate is discarded.

Ultrafiltration provides advantages such as rapid processing, compatibility with various sample volumes, and preservation of exosome integrity and functionality. It can be combined with other isolation methods to further enhance exosome purity. However, it should be noted that ultrafiltration alone may not completely eliminate contaminants, and optimization of membrane selection, pore size, and operating conditions is necessary to achieve the desired purity and concentration.

The use of ultrafiltration for exosome isolation from urine samples has some deficiencies that should be considered. Firstly, urine contains a complex mixture of particles, proteins, and salts, which can affect the efficiency and selectivity of ultrafiltration. The presence of high levels of soluble proteins and salts in urine can lead to clogging or fouling of the ultrafiltration membranes, reducing their permeability and compromising the isolation process. This can result in incomplete removal of contaminants and impure exosome preparations.

Secondly, the low exosome concentration in urine poses a challenge for ultrafiltration-based methods. The diluted nature of urine requires larger sample volumes or concentration steps to obtain a sufficient quantity of exosomes. However, concentration steps can introduce additional challenges, such as potential loss of exosomes during the process or the risk of aggregation due to the high centrifugal forces employed.

Thirdly, ultrafiltration may not provide sufficient resolution to completely separate exosomes from contaminants present in urine. While ultrafiltration membranes have defined molecular weight cutoffs, there is a possibility of non-specific binding and co-filtration of other particles or proteins. This can result in impure exosome preparations, compromising downstream analysis and applications.

Specific types of ultrafiltration such as tangential flow filtration and spin columns, or centrifugal filters as they are often called, can be used for isolation of exosomes from urine and other biological fluids, however, these devices have labor and cost deficiencies and are generally difficult to automate or streamline workflows. Tangential flow filtration devices require complex fluidic setups and/or significant manual manipulation to recover the isolated samples and are complex and often costly. Spin filters or centrifugal filters that contain an ultrafilter or microfilter type membrane filters and can be placed into a centrifuge or in some instances use positive pressure to drive the liquid through are a relatively new device that is now seeing widespread use in these laboratories. These centrifugal spin columns overcome the contamination issues associated with other concentration systems and also overcome many of the issues associated with using centrifugation to concentration biological materials; however, the spin columns are costly, due to their complexity, and still require significant manual manipulation and pipetting during operation.

As described above, each available technique for isolation and concentration of extracellular vesicles and exosomes from biological fluids has its strengths and limitations. Each of these provides less than desirable results in relation to one or more of the purity, yield, concentration factor, scalability, cost and labor requirements. For these reasons, improved approaches for isolation and concentration of extracellular vesicles and exosomes from urine and other biological fluids are needed to both enable current research and to advance research findings towards implementation of extracellular vesicle and exosome-based clinical invitro diagnostic assays.

### SUMMARY OF THE SUBJECT DISCLOSURE

The present applicant has previously described devices and methods for automated manipulation and concentration of particles and large molecules with a disposable fluid path that is capable of processing relatively large volumes of liquids would have significant applicability to clinical diagnostics and microbiology and biotechnology laboratories.

The present applicant holds multiple patents related to methods and devices for concentration of biological particles from liquid samples. These systems use disposable filter tips, or Concentrating Pipette Tips, to capture target particles which are subsequently eluted using wet foam elution. While these devices and methods provide significant utility for concentrating bacteria, viruses and other small particles, the present patent applications provides methods and devices in further sufficient detail to enable those skilled in the art to perform or produce devices or develop methods for more complex operations such as addition of samples through the tip, filter blocking, filter washes, filter fouling reduction steps, and lysis steps using the disposable tips or instruments for operating the disposable tips.

The present subject disclosure describes approaches for treatment and processing of urine samples, media, storage fluids, and biological samples for isolation of extracellular vesicles and exosomes. Specifically, the approaches described are designed to enable processing of urine samples for removal of non-exosomal and non-extracellular vesicle proteins including Tamm-Horsfall protein and albumin, and concentration and buffer exchange of isolated exosomes and/or extracellular vesicles. Further, modifications to these methods enable application to other sample types containing exosomes and/or extracellular vesicles including media, storage fluids, other biological fluids and industrial or environmental waters.

Briefly, the disclosed methods include the following steps performed in the following order, initial sample dilution or sample addition, prefiltration, washing of the prefilter, secondary sample dilution or sample addition, sample capture, sample wash, and sample elution. Variations of this described process are possible as will be understood by those skilled in the art.

The disclosed methods are designed around use of applicant's concentrating pipette, disposable concentrating pipette tips, and concentrating pipette elution fluid for sample capture, sample wash, and sample elution. These devices and associated methods and systems are described in the following U.S. Pat. Nos. 8,584,535, 9,593,359, 9,574,977, 10,955,316, 10,942,097, 10,845,277 and associated Patents Pending. Pending U.S. application Ser. No. 17/726,625 describes the concentrating pipette tip prefilter which can be used for prefiltration steps described in the following methods. All of the cited patents and pending applications in this disclosure are hereby incorporated by reference herein in their entirety into this disclosure.

As required, urine processing methods can be modified to either enable improved non-exosomal and non-extracellular vesicle protein removal, which will generally result in a small increase in exosome or extracellular vesicle losses, or to enable improved recovery of exosomes or extracellular vesicles, which will generally result in a small increase in co-isolated or co-concentrated non-exosomal or non-extracellular vesicle proteins. Certain modifications to these methods may also include reducing agents or detergents which may enable improved reductions or non-exosomal or non-extracellular vesicle proteins or improved recovery of exosomes or extracellular vesicles, but which may result in some denaturing of proteins associated with exosome or extracellular vesicles.

For these and other reasons, certain of these approaches may be used to fit the needs of specific research goals or diagnostic approaches. Further, additional modifications to these approaches, in order to shift to increased exosome or extracellular concentration factors, but to lower non-exosomal or non-extracellular vesicle removal rates, or vice versa, can be employed as will be understood by those well skilled in the art.

The initial sample dilution or sample addition step is used for altering certain characteristics of the urine sample to induce disaggregation or increased aggregation of Tamm-Horsfall protein (THP). THP is a mucin-like glycoprotein that is the most common protein in urine. Aggregation of THP, and the potential for subsequent increased capture of exosomes and extracellular vesicles into these aggregates, is increased at high salt concentrations. Disaggregation and dissolution of THP is increased at lower salt concentrations and under alkaline conditions. Further, reducing agents such as dithiothreitol (DTT), β-mercaptoethanol (β-ME), triethanolamine, CHAPS, arginine, (tris(2-carboxyethyl) phosphine, and urea for example, may be utilized to disrupt protein-protein interactions and protein complexes. These reducing agents may be used individually as part of a buffer solution or in combination in one fluid or by performing multiple washes with these in different buffers. The reducing agent buffers may be used at room temperature or at an elevated temperature from 25° to 65° C. or more preferably from 30° C. to 40° C.

To increase Tamm-Horsfall protein (THP) retention and facilitate the release and passage of exosomes during prefiltration of urine, several buffer additions can be considered. The selection of buffer components should aim to disrupt THP complexes and minimize THP adherence to the filtration membrane while maintaining the stability and integrity of exosomes. Possible buffer additions include detergents, surfactants, chaotropic agents, chelating agents, and pH adjustments as described below.

Nonionic detergents: Nonionic detergents like Triton X-100 or NP-40 can disrupt THP complexes and reduce THP adherence. These detergents can be added to the buffer at appropriate concentrations to promote THP release while having minimal impact on exosome stability.

Zwitterionic detergents: Zwitterionic detergents, such as CHAPS or CHAPSO, can solubilize THP and aid in its release from complexes. These detergents can be added to the buffer to promote THP dissociation while preserving exosome integrity.

Ionic detergents: Ionic detergents, such as SDS, can solubilize and reduce THP to aid in release of exosomes from its complexes. SDS can provide more complete solubilization than CHAPS, Tween 20, and other milder detergents and surfactants, but will likely result in some level of protein denaturation of exosome surface proteins.

Chaotropic agents: Guanidine hydrochloride: Guanidine hydrochloride is a strong chaotropic agent that can disrupt protein-protein interactions and complexes. Its addition to the buffer can facilitate THP release and minimize THP adherence while maintaining exosome stability. Care should be taken to use an appropriate concentration that does not adversely affect exosome integrity.

Urea: Urea is another chaotropic agent that can disrupt THP complexes. Adding urea to the buffer can aid in THP dissociation and reduce THP adhesion while preserving exosome quality.

Chelating agents: Ethylenediaminetetraacetic acid (EDTA): EDTA is a chelating agent that can bind divalent cations and disrupt protein complexes. Incorporating EDTA in the buffer can help release THP from complexes and minimize THP retention on the filtration membrane while preserving exosome stability.

pH adjustments: pH optimization: Modulating the pH of the buffer can influence THP solubility and interactions. Adjusting the pH to specific values (e.g., slightly acidic or alkaline) can enhance THP release and minimize THP adherence to the filtration membrane while maintaining exosome integrity. However, extreme pH values should be avoided to prevent potential exosome damage.

It is important to note that the concentration and compatibility of these buffer additions should be carefully optimized to ensure THP release and exosome stability. Validation experiments and characterization of exosome recovery and quality, such as nanoparticle tracking analysis or protein analysis, should be performed to assess the effectiveness of buffer additions in achieving the desired outcomes.

Overall, the selection and optimization of buffer additions should be based on the specific research goals, characteristics of the urine sample, and the downstream applications for exosome analysis.

The reduction of Tamm-Horsfall protein (THP) involves the transfer of electrons to specific sites within the protein, resulting in a change in its oxidation state. The reduction process can affect the conformation, stability, and functional properties of THP.

When THP is reduced, the specific disulfide bonds within the protein are broken, leading to the formation of sulfhydryl (—SH) groups. Disulfide bonds are covalent bonds between two cysteine residues, and their reduction involves the transfer of electrons to break these bonds.

The reduction of THP can be achieved using reducing agents such as dithiothreitol (DTT), β-mercaptoethanol (β-ME), triethanolamine, CHAPS, urea, and other reducing agents that will be well known to those skilled in the art. Further, reducing agents may be used by themselves in water or buffer or in combination with other reducing agents, detergents, surfactants, or other additives. These reducing agents donate electrons to the disulfide bonds, resulting in the cleavage of the bonds and the generation of sulfhydryl groups.

The reduction of THP can have several effects on the protein, including: (1) Structural changes: The breaking of disulfide bonds can cause conformational changes in THP. The reduction can lead to the unfolding or relaxation of protein structure, altering its three-dimensional arrangement. (2) Solubility: Reduction can increase the solubility of THP by disrupting intermolecular interactions that contribute to aggregation or precipitation. The formation of sulfhydryl groups can enhance the solubilization of THP in certain solvents or buffer conditions. (3) Functional modifications: Reduction of THP can affect its functional properties. THP is known to interact with other proteins, carbohydrates, and components in urine. Reduction may alter these interactions, affecting THP's roles in urinary tract health, immune response modulation, or other functions.

It is important to note that the reduction of THP can be reversible, and the protein may regain its native conformation and function upon removal of the reducing agent. Additionally, the extent of reduction can depend on factors such as the concentration of the reducing agent, reaction conditions, and the specific disulfide bonds within THP.

The study of THP reduction and its impact on protein structure, function, and interactions can provide insights into the role of disulfide bonds and the functional regulation of THP in various physiological or pathological contexts.

The present disclosure addresses the problem outlined and advances the art by providing a highly efficient filtration-based particle and large molecule concentration and manipulation system in which the sample matrix and target materials only come into contact with a disposable filter tip. The described disposable filter tip and methods of processing samples through the tip and eluting a concentrated sample is disclosed in applicant's earlier patent applications, which have been incorporated by reference herein in their entirety. The disposable tip has been termed the Concentrating Pipette Tip (CPT) by the applicant. The newly disclosed device and method advance significantly upon the earlier subject disclosure by enabling a number of complex operations that provide for improved capabilities for processing samples; providing improved quality to processed and concentrated samples.

More specifically the disclosed system is capable of increasing sample volumes processed, improving concentration efficiencies, and reducing co-concentrated inhibitors. Further, the system enables onboard lysis and bypass of currently necessary downstream extraction protocols, or integration with those processes—thereby enabling end-to-end automation of concentration, extraction, and purification of target particles.

The devices and methods described here enable end-to-end automated systems for replacement of continuous flow and low-, high- and ultra-speed centrifugation, as well as centrifugal and tangential flow filtration in the laboratory. Cell washing, concentration/staining/labeling for cytometry and microscopy, purification and concentration of circulating tumor cells, microbes, viruses, bacteriophages, proteins, extracellular vesicles, and other particles and large molecules will be possible with the described device and methods.

### BRIEF DESCRIPTION OF THE DRAWINGS

FIGS. 1-4 show flow charts of disclosed workflows for processing of urine and other biological fluids for isolation and concentration of extracellular vesicles and exosomes. FIGS. 5 and 6 show prefilter devices for use in these workflows. FIGS. 7A and 7B show previously described prefilters for use with concentrating pipette tips, which can be used with these workflows.

FIG. 1 shows a workflow for a method of using dilution of urine in an alkaline Tris/EDTA buffer prior to prefiltration and isolation and concentration using the concentrating pipette, according to an exemplary embodiment of the present subject disclosure.

FIG. 2 shows a workflow for a method for processing undiluted urine samples prior to prefiltration, a prefilter wash step, and isolation and concentration using the concentrating pipette, according to an exemplary embodiment of the present subject disclosure.

FIG. 3 shows a workflow for a method for processing undiluted urine samples prior to prefiltration, a reducing agent treatment step, a prefilter wash step, and isolation and concentration using the concentrating pipette, according to an exemplary embodiment of the present subject disclosure.

FIG. 4 shows a workflow for a method of using salt precipitation of urine prior to prefiltration and isolation and concentration using the concentrating pipette, according to an exemplary embodiment of the present subject disclosure.

FIG. 5 shows a commercially available membrane filter prefiltration device for use with the described methods, according to an exemplary embodiment of the present subject disclosure.

FIG. 6 shows a commercially available fiber prefilter for use along with membrane filter prefiltration devices, according to an exemplary embodiment of the present subject disclosure.

FIGS. 7A and 7B show two views of a previously described concentrating pipette tip prefilter for use with the described methods, according to an exemplary embodiment of the present subject disclosure.

### DETAILED DESCRIPTION OF THE SUBJECT DISCLOSURE

The present subject disclosure is a method for isolating exosomes, extracellular vesicles, microvesicles, apoptotic bodies, or other biological particles from raw or stabilized urine and other biological fluids.

In the following figures, methods are shown and described which utilize one or more of multiple configurations of the concentrating pipette, disposable concentrating pipette tips, concentrating pipette tip prefilters, and concentrating pipette elution fluid. These devices and associated methods and systems are described in the following U.S. Pat. Nos. 8,584,535, 9,593,359, 9,574,977, 10,955,316, 10,942,097, 10,845,277 and associated Patents Pending. Of the patents pending, U.S. application Ser. No. 17/726,625 describes the concentrating pipette tip prefilter which can be used for prefiltration steps described in the following methods. All of the cited patents and pending applications in this disclosure are hereby incorporated by reference herein in their entirety into this disclosure.

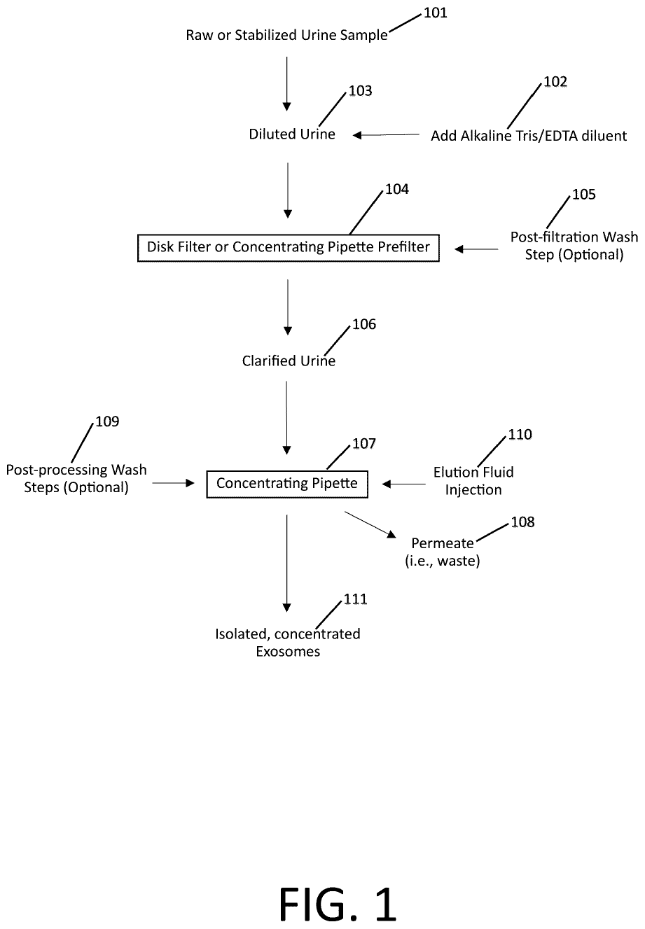

FIG. 1 shows a flow chart of a workflow for isolation and concentration of exosomes from raw or stabilized urine using a dilution, followed by prefiltration, and then by further isolation and concentration using the Applicant Concentrating Pipette, according to an exemplary embodiment of the present subject disclosure. The workflow is optimized for isolation and concentration of exosomes, but may be used for isolation and concentration of other biological particles, with some modifications to the workflow, including extracellular vesicles, microvesicles, and apoptotic bodies, as will be understood by those skilled in the art.

The workflow enables the isolation and concentration of exosomes from urine samples while minimizing interference from larger Tamm-Horsfall protein complexes, other non-exosome and non-extracellular vesicle associated proteins including albumin, and cells and cell debris. The method is designed to be user friendly with minimal steps in its simplest form, but optional wash steps can also be performed to further improve upon the efficiency of exosome isolation and concentration or to further improve upon the Tamm-Horsfall protein or albumin removal efficiency.

As shown in FIG. 1, raw or previously stabilized urine sample 101 is first diluted with alkaline Tris/EDTA diluent buffer 102 to initiate disruption of Tamm-Horsfall protein aggregates. To prepare the alkaline Tris/EDTA dilution buffer 102, Tris-HCL and EDTA are dissolved in sterile water and the pH is adjusted to alkaline (e.g., pH 8.5-10.0) using sodium hydroxide. Alternatively, Tris base or other buffers may alternatively be used, in combination or alone, to create the appropriate buffered alkaline solution as will be well known to those skilled in the art. The Tris buffer concentration may range from 0.05 mM to 1 M, or more commonly from 0.1 mM to 0.5 mM. The pH will generally be between 8.0 and 11.0, but more commonly between 8.5 and 10.0.

The described diluent buffer will generally contain EDTA (ethylenediaminetetraacetic acid) in order to chelate metal ions, including Ca²⁺, in the urine sample, but may be prepared without EDTA or with alternative chelators. Alternative chelators include EGTA, DTPA, Citrate, Desferrioxamine, and NTA, but a range of other chelators may be utilized as will be well understood by those skilled in the art. As a chelating agent, EDTA forms stable complexes with metal ions by coordinating with the metal ions through its multiple binding sites. This chelation process along with the alkaline pH helps to prevent and reverse aggregation of Tamm-Horsfall protein and release entrapped exosomes.

Other additives may also be used to further enhance disaggregation of Tamm-Horsfall protein and release entrapped exosomes. These additives include, but are not limited to surfactants, detergents, reducing agents, or other additives. Further, these additives may also be used to reduce losses of exosomes during prefiltration and during concentration with the Concentrating Pipette. Surfactants and detergents including polysorbates (e.g., Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art. The concentrations of surfactants can be adjusted over a wide range to enhance or reduce disaggregation of Tamm-Horsfall proteins as desired and to reduce the potential of protein denaturation as required, as will be well understood by those skilled in the art.

The raw or stabilized urine sample 101 is diluted by adding the diluent buffer 102, or by adding the urine 101 to the diluent buffer 102, to achieve the desired dilution ratio. Dilution ratios can range from 1:1 to as high as 1:10 (urine: buffer), but more specifically will be from 1:2 to 1:6. Following addition of the diluent, the sample is thoroughly mixed by inversion, stirring, or vortexing to produce the diluted urine 103. The sample may then be incubated for a period of time to enhance disaggregation of the Tamm-Horsefall proteins. Generally, the incubation period will range from 30 seconds up to 30 minutes, but more commonly from 1 minute to 5 minutes prior to processing by prefiltration.

While the use of alkaline Tris/EDTA dilution buffer 102 has been previously described for use in disaggregation of Tamm-Horsfall protein in urine samples during extracellular vesicle isolation, the previously disclosed methods have utilized a multi-step process of low speed centrifugation (1800×g) for cell removal, followed by dilution in with the Tris/EDTA buffer, followed by a second low speed centrifugation (8000×g), followed by filtration with a 1.2 μm filter, followed by ultracentrifugation for final isolation of the extracellular vesicles. This previously described workflow is complex and still does not sufficiently remove Tamm-Horsfall protein. Even the combined steps of two low speed centrifugation steps and a prefiltration step are insufficient because g-force used during the centrifugation step is too low to efficiently pellet Tamm-Horsfall and the prefilter pore size is too large to efficiently capture Tamm-Horsfall. When performed following disaggregation of the Tamm-Horsfall proteins, the result is that higher concentrations of Tamm-Horsfall are present in the final isolated sample than if no dilution step is performed and the same centrifugation and filtration steps are utilized.

Further, the use of multiple centrifugation and filtration steps together is often employed to ensure that exosomes are not lost to large centrifugation pellets or in a large layer of fouling material on the filter surface. While exosome losses in this way are of concern, each additional treatment step results in additional exosome loss to surfaces and material in the sample and also increases labor requirements and cost, and can increase the potential for technician error.

The described workflow overcomes these issues by using a single, post dilution, filtration step through a disk filter or concentrating pipette prefilter 104 to remove large cells and Tamm-Horsfall proteins, by relying upon either very large prefilter surface areas or graded depth filtration, or a combination of the two. For clarity, depth filtration refers to the use of a depth filter, which is most generally a fiber filter that captures particles throughout the thickness of the fiber rather than on the surface, as a membrane filter generally does. Graded depth filtration uses a graded depth filter, which is a fiber filter with a coarser more open structure on one side which transitions toward a tighter structure on the other side.

With graded depth filters the flow most commonly proceeds from the coarser, more open side, towards the tighter side. In this way, the filter is able to hold larger quantities of material within the structure without building up a fouling, gel layer as commonly occurs during filtration of proteinaceous fluids through a membrane filter.

By using these approaches, a single prefiltration step is required before isolation and concentration, and the prefilter 104 is much less susceptible to surface fouling which can lead to exosome losses. Further, the large surface area or graded depth filtration enable selection of tighter filter pore sizes which improve capture of the Tamm-Horsfall proteins while still allowing exosomes to pass through. Even after treatment by dilution the Tamm-Horsfall proteins and protein aggregates are linear in nature which provides for efficient removal by prefiltration with pore sizes that are still able to pass the exosomes through to the permeate.

Prefiltration to remove Tamm-Horsfall protein and protein aggregates and complexes as well as cells, while allowing exosomes to pass, is preferably performed using a fiber filter prefilter followed by a membrane filter. In this way, the fiber filter is able to hold a significant mass of non-exosomal material without creating a gel layer as would be created on a small surface area membrane filter. When using only a small diameter membrane filter, the buildup of a gel layer results in fouling and entrapment of exosomes resulting in significant losses of exosomes.

Appropriate fiber filters for use in this application may be made from glass fiber, quartz fiber, cellulose fiber, polypropylene, PTFE, polyamide or nylon, polyester and other natural or synthetic materials as will be well understood by those skilled in the art. A fiber filter pore size range from 0.1 μm to 25 μm is recommend, with a more preferred range of fiber filter pore sizes from 0.2 μm to 5.0 μm. In this way, the fiber filter is able to retain larger particles, including Tamm-Horsfall protein complexes and cells, but provides a torturous path in which the protein complexes can be captured rather than building up a fouling layer on the surface of the filter.

Additionally, graded fiber filters, which have a larger pore size on the first surface contacted by the fluid and a smaller pore size on the last surface contacted by the fluid, are advantageous. Similarly, two or more fiber filters may be stacked to provide a graded filter. When using graded fiber filters on top of a membrane filter, the first contacted surface will have a recommended pore size range from 0.5 μm to 25 μm, with a more preferred range of fiber filter pore sizes from 1.0 μm to 10 μm. In this case, the last contacted surface will have a recommended pore size range from 0.1 μm to 10 μm, with a more preferred range of fiber filter pore sizes from 0.2 μm to 5 μm.

Appropriate membrane filters for use as a final stage prefiltration in this application may be manufactured from various polymers, including but not limited to polyethersulfone (PES), polyvinylidene fluoride (PVDF), polytetrafluoroethylene (PTFE), nylon, cellulose acetate, cellulose ester, polycarbonate, polypropylene, and other natural or synthetic materials as will be well understood by those skilled in the art. A membrane filter pore size range from 0.05 μm to 5 μm is recommended, with a more preferred range of fiber filter pore sizes from 0.1 μm to 0.8 μm. In this way, the fiber filter is able to retain larger particles, including Tamm-Horsfall protein complexes and cells, but is able to pass exosomes efficiently. Further the membrane filter pore size may be selected for passage of extracellular vesicles, microvesicles, and apoptotic bodies.

Based on the range of concentrations of Tamm-Horsfall protein in urine, a large membrane surface area must be used to further ensure that a significant fouling, gel layer does not build up on the membrane surface and cause losses of exosomes. For this reason, a membrane filter diameter ranging from 37 mm to 150 mm is recommended, with a more preferred diameter range from 47 mm to 125 mm. Further, when using smaller diameter membrane filters in the 37 mm to 110 mm range, a thicker and tighter fiber filter should be used to allow for capture of Tamm-Horsfall protein complexes throughout the fiber filter matrix and thus a reduction of the gel fouling layer. Additionally, pleated membrane filters or hollow fiber membrane filters may be utilized to condense a larger surface area into a small device as will be well understood by those skilled in the art.

Alternatively, to the combined large membrane filter surface area and fiber filter prefilter, a thicker and tighter graded fiber prefilter may be utilized to perform the prefiltration step. In this case, the larger surface area of the described membrane filter is replaced with a thicker and tighter fiber filter that enables the Tamm-Horsfall complexes to be captured throughout the filter matrix and therefor not build up a fouling gel layer. One specific example of this type of approach is the Applicant concentrating pipette tip prefilter which uses a graded 0.9 μm glass fiber filter with a nominal thickness of 5 mm and a nominal surface area of 18 cm². With this filter the first contacted surface has a significantly larger pore size than the last contacted surface which enables deposition of the protein complexes throughout the matrix.

In the case of a graded fiber filter used alone without a membrane filter, the total internal volume of the filter (thickness in centimeters times the surface area in cm²) should range from 4 cm³ to 60 cm³ or more preferably from 5 cm³ to 50 cm³. Further, for the graded fiber filter the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm. These specifications allow for capture of the Tamm-Horsfall proteins throughout the internal filter volume while enabling efficient pass of exosomes. Further the filter pore size may be selected for passage of extracellular vesicles, microvesicles, and apoptotic bodies.

Alternatively, if a non-graded fiber filter is used alone without a membrane filter, the total internal volume of the filter (thickness in centimeters times the surface area in cm²) should range from 4 cm³ to 60 cm³ or more preferably from 5 cm³ to 50 cm³. Further, for the graded fiber filter the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm. These specifications allow for capture of the Tamm-Horsfall proteins throughout the internal filter volume while enabling efficient pass of exosomes. Further the filter pore size may be selected for passage of extracellular vesicles, microvesicles, and apoptotic bodies.

To perform the prefiltration, the diluted urine sample is poured into a prefiltration device, such as a Stericup Quick Release-HV Sterile Vacuum Filtration System—Millipore item #S2GPU01RE, 150 ml capacity, sterile, 0.22 μm pore size polyethersulfone (73 mm, 40 cm² surface area) with a glass fiber prefilter on top of the Stericup filter to reduce filter fouling and exosome losses.

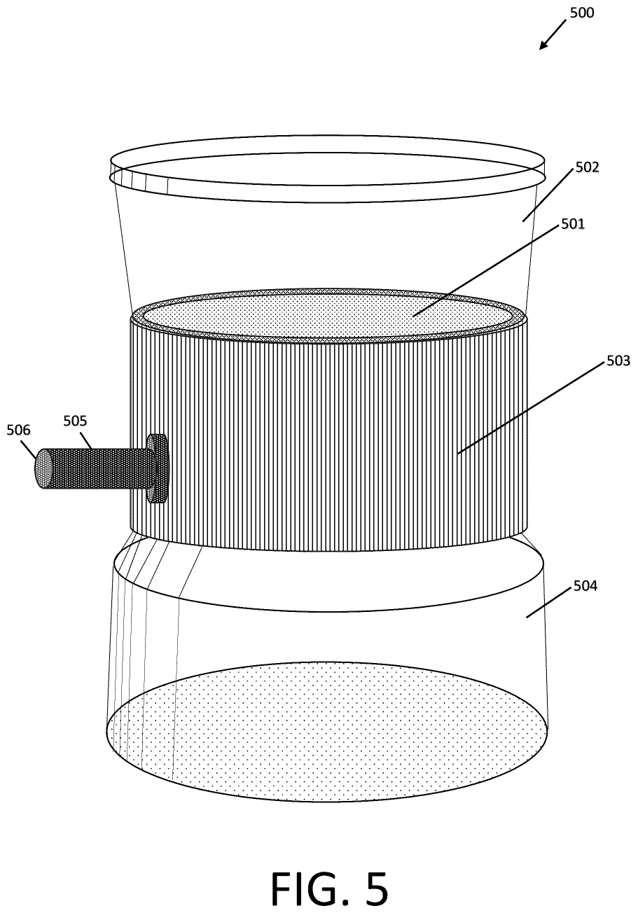

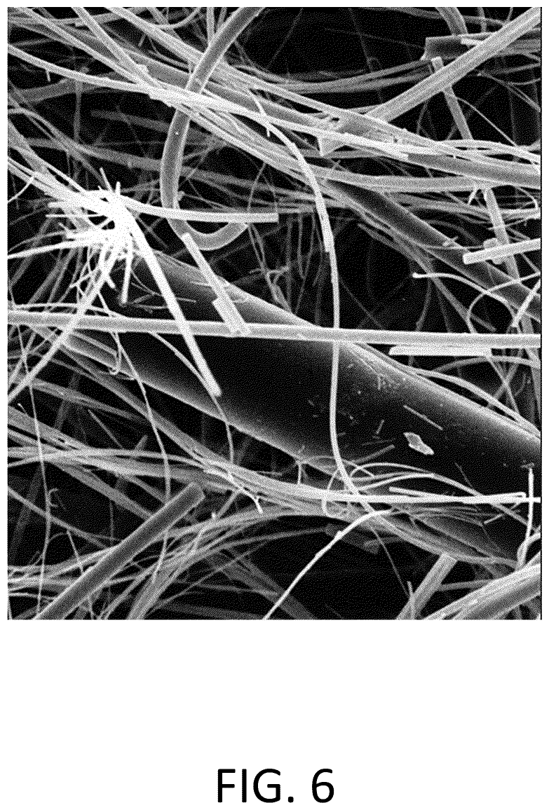

This prefiltration device 500 is shown in FIG. 5. One possible prefilter that can be used with the described Stericup item #S2GPU01RE is Millipore item #AP2007500, 2.0 μm pore size, hydrophilic glass fiber filter with binder resin, 75 mm diameter, shown in FIG. 6, or Millipore item #AP1507500 1.0 μm pore size, hydrophilic glass fiber filter with binder resin, 75 mm diameter.

After pouring the diluted urine sample into the prefiltration device, gentle pressure, vacuum, or gravity flow can be used to drive the liquid through the membrane. In the case of the described Stericup devices, it is recommended to apply roughly 1 atmosphere of negative pressure to the filter device, so that a high flow rate of liquid is created through the membrane filter. Using higher negative pressure, rather than low negative pressure or gravity flow, enables a higher flow rate of liquid through the membrane filter and acts to flush exosomes trapped within Tamm-Horsfall complexes out and into the filter permeate.

After filtering the diluted urine sample an optional Post-filtration wash step 105 may be performed to further improve recovery of exosomes or extracellular vesicles from the sample. A range of wash buffers may be used including, but not limited to, alkaline Tris/EDTA diluent buffer, sterile water, buffered water, buffered water plus alternative chelators, surfactants, detergents, reducing agents, or other additives. Surfactants and detergents including polysorbates (e.g., Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

Other fluids and buffers that may be used include, but are not limited to RIPA buffer, HEPES buffered saline, Tris buffered saline, and phosphate-buffered saline. The concentrations of surfactants can be adjusted over a wide range to enhance or reduce disaggregation of Tamm-Horsfall proteins as desired and to reduce the potential of protein denaturation as required, as will be well understood by those skilled in the art. Further, any of these components and buffers may be used alone or in combination with each other or other similar components and buffers, as will be well understood by those skilled in the art.

Specifically recommended wash formulations with Tween 20 for improving recovery include, but are not limited to, alkaline Tris/EDTA diluent buffer plus 1% Tween 20, PBS plus 1% Tween 20, and Tris buffer plus 1% Tween 20. These wash formulations should be added into the filter apparatus at a volume equivalent to roughly ⅕^{th} of the diluted urine sample volume. In this way a final Tween 20 concentration of 0.2% is achieved in the final filtered sample. A range of wash volumes from 1 mL to 100 mL or more preferred from 5 mL to 50 mL can be used. A Tween 20 concentration in the wash can be used from 0.01% to 10% or more preferred from 0.1% to 5%. A range of other formulations can be used that will enable improved recovery of exosomes and extracellular vesicles while not resulting in significant denaturing of associated proteins, as will be well understood by those skilled in the art.

To perform the wash step 105 the wash fluid is added to the top of the prefilter and is either drawn through using gentle pressure, vacuum, or gravity flow. The wash fluid may also be left on the prefilter with no vacuum or pressure applied to the filter apparatus. The wash fluid is left in place for a short incubation period ranging from 10 seconds to 10 minutes or more preferably from 30 seconds to 5 minutes, after which negative pressure is applied to the assembly to quickly draw the wash fluid through and into the same container holding the filtered diluted urine sample.

If desired additional wash steps may be performed to further improve the exosome or extracellular vesicle recovery. The user then removes the filtrate sample container, which contains the filtered diluted urine sample plus fluid from any wash steps performed. This filtered sample now contains smaller particles, including exosomes and other target particles, while the retained larger complexes and cells remain on the filter.

After prefiltration of the diluted urine sample, and any wash steps performed, is complete, the exosomes or extracellular vesicles contained within the clarified urine 106 are concentrated using the concentrating pipette instrument 107 using Ultrafilter or 0.05 μm pore size concentrating pipette tips. The sample can be aspirated directly from the prefilter 104 assembly sample container or transferred to another container before processing. Surfactant additions or reducing agents may also be added to the sample prior to processing with the concentrating pipette instrument if additional solubilization of the Tamm-Horsfall proteins is desired, so that removal of the protein can be enhanced.

The concentrating pipette 107 instrument is operated using standard operational instructions for the instrument. The filtered, diluted, clarified urine 106 sample is placed on the instrument sample tray, the instrument arm and fluidics head are then raised. A concentrating pipette tip is attached to the head by the user via an interface. The arm is then lowered so that the concentrating pipette tip is submerged in the sample. The user then starts the concentrating unit by inputting commands via a user interface, and the sample is aspirated into the concentrating pipette tip and begins passing through the hollow fiber membrane filters in tip and waste is dispense to the permeate 108. When the entire sample has been processed the user is alerted that the sample has been processed. The user may then choose to elute the sample or perform a wash step.

One more post-processing wash steps 109 can be performed to assist in flushing additional Tamm-Horsfall and other non-exosomal or non-extracellular vesicle associated proteins through to the permeate 108. A range of wash fluids may be used including, but not limited to, alkaline Tris/EDTA diluent buffer, sterile water, buffered water, buffered water plus alternative chelators, surfactants, detergents, reducing agents, or other additives. Surfactants and detergents including polysorbates (e.g. Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art. Reducing agents include dithiothreitol (DTT), β-mercaptoethanol (β-ME), triethanolamine, CHAPS, and urea for example, but many other reducing agents may be used individually or in combination as will be well understood by those skilled in the art.

Other fluids and buffers that may be used include, but are not limited to RIPA buffer, HEPES buffered saline, Tris buffered saline, and phosphate-buffered saline. The concentrations of surfactants can be adjusted over a wide range to enhance or reduce disaggregation of Tamm-Horsfall proteins as desired and to reduce the potential of protein denaturation as required, as will be well understood by those skilled in the art. Further, any of these components and buffers may be used alone or in combination with each other or other similar components and buffers, as will be well understood by those skilled in the art.

Specifically recommended wash formulations with Tween 20 for improving recovery include, but are not limited to, alkaline Tris/EDTA diluent buffer plus 1% Tween 20, PBS plus 1% Tween 20, and Tris buffer plus 1% Tween 20. These wash formulations should be added into the filter apparatus at a volume equivalent to roughly ⅕^{th} of the diluted urine sample volume. In this way a final Tween 20 concentration of 0.2% is achieved in the final filtered sample. A range of wash volumes from 1 mL to 100 mL or more preferred from 5 mL to 50 mL can be used. A Tween 20 concentration in the wash can be used from 0.01% to 10% or more preferred from 0.1% to 5%. A range of other formulations can be used that will enable improved recovery of exosomes and extracellular vesicles while not resulting in significant denaturing of associated proteins, as will be well understood by those skilled in the art.

Additionally, following a reducing agent step, the use of an alkaline wash step may be used to further improve removal of exosomes from Tamm-Horsfall complexes. The alkaline wash may include from 50 mM to 250 mM of Na₂CO₃ with a pH between 9.0 and 11.5. More specifically, a 100 mM to 200 mM of Na₂CO₃ with a pH between 10.5 and 11.5, may be used. Other alkaline wash formulations may be used as will be well understood by those skilled in the art.

Additional wash steps 109 may be performed as desired to remove additional contaminating materials, improve the buffer exchange, improve exosome recovery, or remove components introduced in the dilution fluid, prefilter wash steps, or the initial concentrating pipette wash step. Formulations the same or similar to those recommended for use in the prefilter wash step can be used at the same or similar concentrations.

Specifically, the use of an alkaline wash step 109 may be used to further improve removal of Tamm-Horsfall and other proteins prior to elution. The alkaline wash may include from 50 mM to 250 mM of Na₂CO₃ with a pH between 9.0 and 11.5. More specifically, a 100 mM to 200 mM of Na₂CO₃ with a pH between 10.5 and 11.5, may be used. A 25 mM Tris/1 mM EDTA solution with a pH between 9 and 11 may be used as a wash fluid as well. The tris concentration of this fluid may range from 5 mM to 1 M or more preferably from 10 mM to 50 mM. The EDTA concentration may range from 0.1 mM to 1 M or more preferably from 0.25 mM to 10 mM. Other alkaline wash formulations may be used as will be well understood by those skilled in the art.

Immediately after the sample is processed, or after performing concentrating pipette wash steps 109, elution can be performed by elution fluid injection 110, resulting in a final sample containing isolated, concentrated exosomes 111. The elution can be performed using Applicant's current standard elution fluid formulation or custom or newly developed elution fluids. The current standard elution fluids are PBS/0.075% Tween 20 solution under a carbon dioxide head pressure of 125 psi nominal and 25 mM Tris/0.075% Tween 20, also under carbon dioxide head pressure. Alternative formulations include other buffer formulations along with alternative surfactants—used as foaming agents.

Surfactants and detergents that can be used as the foaming agent in the elution fluid includes polysorbates (e.g. Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

In addition to carbon dioxide other gases can be used to produce the foam. Nitrous oxide is highly soluble like carbon dioxide and makes an excellent elution fluid, but other less soluble gases can also be added to the formulation, including nitrogen and other inert gases.

The described method for producing isolated, concentrated exosomes 111 using dilution, prefiltration, concentration, and elution steps provides an improved approach for obtaining isolated and concentrated exosomes from urine samples. The method addresses the limitations of existing techniques and offers enhanced efficiency and convenience for exosome isolation and downstream applications. While the above description contains specific details for the implementation of the method, it should be understood that variations and modifications can be made within the scope of the subject disclosure. These modifications can be made to further improve the workflow or isolation efficiencies but may also be made to isolate other targets including extracellular vesicles, microvesicles, and apoptotic bodies, for instance.

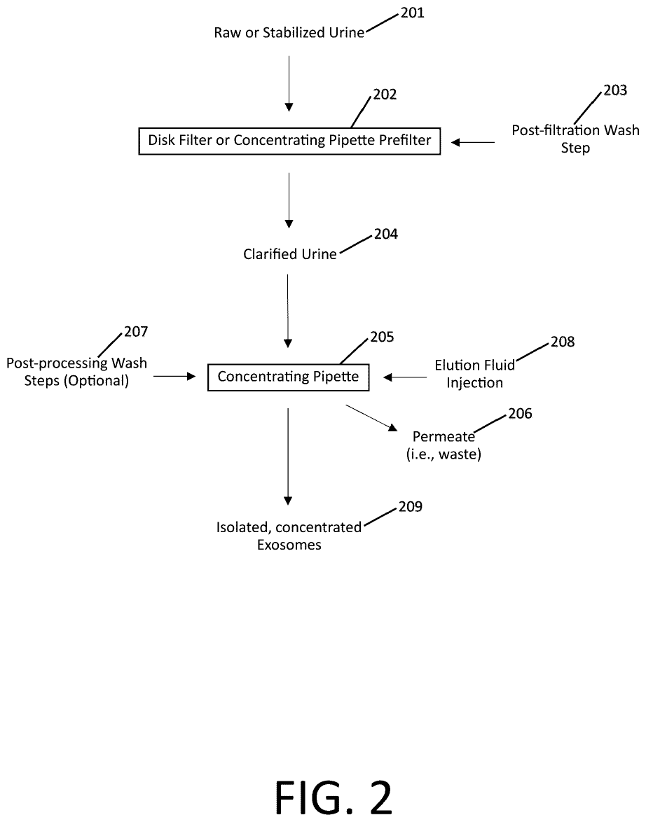

As shown in FIG. 2, raw or stabilized urine 201 is processed undiluted through a prefiltration step, followed by a post-filtration wash step to improve recovery of exosomes that may be entrapped within protein complexes or other debris. The clarified urine is then processed using the concentrating pipette and was steps may be performed prior to elution to further improve removal of Tamm-Horsfall protein and other non-exosomal or non-extracellular associated proteins. The isolated exosomes are then eluted into a small final volume of elution fluid.

Prefiltration to remove Tamm-Horsfall protein and protein aggregates and complexes as well as cells, while allowing exosomes to pass is preferably performed using a fiber filter prefilter followed by a membrane filter. In this way, the fiber filter is able to hold a significant mass of non-exosomal material without creating a gel layer as would be created on a small surface area membrane filter. When using only a small diameter membrane filter the buildup of a gel layer results in fouling and entrapment of exosomes resulting in significant losses of exosomes.

Appropriate fiber filters for use in this application may be made from glass fiber, quartz fiber, cellulose fiber, polypropylene, PTFE, polyamide or nylon, polyester and other natural or synthetic materials as will be well understood by those skilled in the art. A fiber filter pore size range from 0.1 μm to 25 μm is recommend with a more preferred range of fiber filter pore sizes from 0.2 μm to 5.0 μm. In this way, the fiber filter is able to retain larger particles, including Tamm-Horsfall protein complexes and cells, but provides a torturous path in which the protein complexes can be captured rather than building up a fouling layer on the surface of the filter.

Additionally, graded fiber filters, which have a larger pore size on the first surface contacted by the fluid and a smaller pore size on the last surface contacted by the fluid, are advantageous. Similarly, two or more fiber filters may be stacked to provide a graded filter. When using graded fiber filters on top of a membrane filter, the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm.

Appropriate membrane filters for use as a final stage prefiltration in this application may be manufactured from various polymers, including but not limited to polyethersulfone (PES), polyvinylidene fluoride (PVDF), polytetrafluoroethylene (PTFE), nylon, cellulose acetate, cellulose ester, polycarbonate, polypropylene, and other natural or synthetic materials as will be well understood by those skilled in the art. A membrane filter pore size range from 0.05 μm to 5 μm is recommended with a more preferred range of fiber filter pore sizes from 0.1 μm to 0.8 μm. In this way, the fiber filter is able to retain larger particles, including Tamm-Horsfall protein complexes and cells, but is able to pass exosomes efficiently. Further the membrane filter pore size may be selected for passage of extracellular vesicles, microvesicles, and apoptotic bodies.

Based on the range of concentrations of Tamm-Horsfall protein in urine, a large membrane surface area must be used to further ensure that a significant fouling, gel layer does not build up on the membrane surface and cause losses of exosomes. For this reason, a membrane filter diameter ranging from 37 mm to 150 mm is recommended, with a more preferred diameter range from 47 mm to 125 mm. Further, when using smaller diameter membrane filters in the 37 mm to 110 mm range a thicker and tighter fiber filter should be used to allow for capture of Tamm-Horsfall protein complexes throughout the fiber filter matrix and thus a reduction of the gel fouling layer. Additionally, pleated membrane filters or hollow fiber membrane filters may be utilized to condense a larger surface area into a small device as will be well understood by those skilled in the art.

Alternatively, to the combined large membrane filter surface area and fiber filter prefilter, a thicker and tighter graded fiber prefilter may be utilized to perform the prefiltration step. In this case, the larger surface area of the described membrane filter is replaced with a thicker and tighter fiber filter that enables the Tamm-Horsfall complexes to be captured throughout the filter matrix and therefore not build up a fouling gel layer. One specific example of this type of approach is the Applicant concentrating pipette tip prefilter which uses a graded 0.9 μm glass fiber filter with a nominal thickness of 5 mm and a nominal surface area of 18 cm². With this filter the first contacted surface has a significantly larger pore size than the last contacted surface which enables deposition of the protein complexes throughout the matrix.

In the case of a graded fiber filter used alone without a membrane filter, the total internal volume of the filter (thickness in centimeters times the surface area in cm²) should range from 4 cm³ to 60 cm³ or more preferably from 5 cm³ to 50 cm³. Further, for the graded fiber filter the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm. These specifications allow for capture of the Tamm-Horsfall proteins throughout the internal filter volume while enabling efficient pass of exosomes. Further the filter pore size may be selected for passage of extracellular vesicles, microvesicles, and apoptotic bodies.

Alternatively, if a non-graded fiber filter is used alone without a membrane filter, the total internal volume of the filter (thickness in centimeters times the surface area in cm²) should range from 4 cm³ to 60 cm³ or more preferably from 5 cm³ to 50 cm³. Further, for the graded fiber filter the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm. These specifications allow for capture of the Tamm-Horsfall proteins throughout the internal filter volume while enabling efficient pass of exosomes. Further the filter pore size may be selected for passage of extracellular vesicles, microvesicles, and apoptotic bodies.

To perform the prefiltration, the urine sample is poured into the prefiltration device, such as a Stericup Quick Release-HV Sterile Vacuum Filtration System-Millipore item #S2GPU01RE, 150 mL capacity, sterile, 0.22 μm pore size polyethersulfone (73 mm, 40 cm² surface area) with a glass fiber prefilter on top of the Stericup filter to reduce filter fouling and exosome losses. This prefiltration device 500 is shown in FIG. 5. One possible prefilter that can be used with the described Stericup item #S2GPU01RE is Millipore item #AP2007500, 2.0 μm pore size, hydrophilic glass fiber filter with binder resin, 75 mm diameter, shown in FIG. 6, or Millipore item #AP1507500 1.0 μm pore size, hydrophilic glass fiber filter with binder resin, 75 mm diameter.

To perform the described operation a sample of raw or stabilized urine 201 is processed through a disk filter or concentrating pipette prefilter 202 using gentle pressure, vacuum, or gravity flow to drive the liquid through the membrane. In the case of the described Stericup devices, it is recommended to apply roughly 1 atmosphere of negative pressure to the filter device, so that a high flow rate of liquid is created through the membrane filter. Using higher negative pressure, rather than low negative pressure or gravity flow, enables a higher flow rate of liquid through the membrane filter and acts to flush exosomes trapped within Tamm-Horsfall complexes out and into the filter permeate.

After filtering the urine sample an optional post-filtration wash step 203 may be performed to further improve recovery of exosomes or extracellular vesicles from the sample. A range of wash buffers may be used including, but not limited to, alkaline Tris/EDTA diluent buffer, sterile water, buffered water, buffered water plus alternative chelators, surfactants, detergents, reducing agents, or other additives. Surfactants and detergents including polysorbates (e.g., Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

Other fluids and buffers that may be used include, but are not limited to RIPA buffer, HEPES buffered saline, Tris buffered saline, and phosphate-buffered saline. The concentrations of surfactants can be adjusted over a wide range to enhance or reduce disaggregation of Tamm-Horsfall proteins as desired and to reduce the potential of protein denaturation as required, as will be well understood by those skilled in the art. Further, any of these components and buffers may be used alone or in combination with each other or other similar components and buffers, as will be well understood by those skilled in the art.

Specifically recommended wash formulations with Tween 20 for improving recovery include, but are not limited to, alkaline Tris/EDTA diluent buffer plus 1% Tween 20, PBS plus 1% Tween 20, and Tris buffer plus 1% Tween 20. These wash formulations should be added into the filter apparatus at a volume equivalent to roughly ⅕^{th} of the urine sample volume. In this way a final Tween 20 concentration of 0.2% is achieved in the final filtered sample. A range of wash volumes from 1 mL to 100 mL or more preferred from 5 mL to 50 mL can be used. A Tween 20 concentration in the wash can be used from 0.01% to 10% or more preferred from 0.1% to 5%. A range of other formulations can be used that will enable improved recovery of exosomes and extracellular vesicles while not resulting in significant denaturing of associated proteins, as will be well understood by those skilled in the art.

To perform the post-filtration wash step 203 the wash fluid is added to the top of the prefilter and is either drawn through using gentle pressure, vacuum, or gravity flow. The wash fluid may also be left on the prefilter with no vacuum or pressure applied to the filter apparatus. The wash fluid is left in place for a short incubation period ranging from 10 seconds to 10 minutes or more preferably from 30 seconds to 5 minutes, after which negative pressure is applied to the assembly to quickly draw the wash fluid through and into the same container holding the filtered urine sample.

If desired additional wash steps may be performed to further improve the exosome or extracellular vesicle recovery. The user than removes the filtrate sample container, which contains the filtered urine sample plus fluid from any wash steps performed. This filtered sample now contains smaller particles, including exosomes and other target particles, while the retained larger complexes and cells remain on the filter.

After prefiltration of the urine sample, and any wash steps performed, are complete the clarified urine 204 is processed using a concentrating pipette instrument 205 exosomes or extracellular vesicles are concentrated using Ultrafilter or 0.05 μm pore size concentrating pipette tips. The sample can be aspirated directly from the prefilter assembly sample container or transferred to another container before processing. Surfactant additions or reducing agents may also be added to the sample prior to processing with the concentrating pipette instrument if additional solubilization of the Tamm-Horsfall proteins is desired, so that removal of the protein can be enhanced.

The concentrating pipette 205 instrument is operated using standard operational instructions for the instrument. The clarified urine 204 sample is placed on the instrument sample tray, the instrument arm and fluidics head are then raised. A concentrating pipette tip is attached to the head by the user via an interface. The arm is then lowered so that the concentrating pipette tip is submerged in the sample. The user then starts the concentrating pipette 205 by inputting commands via a user interface, and the sample is aspirated into the concentrating pipette tip and begins passing through the hollow fiber membrane filters in tip and permeate 206 is dispensed to a waste container. When the entire sample has been processed the user is alerted that the sample has been processed. The user may then choose to elute the sample or perform a post-processing wash step 207.

One more post-processing wash steps 207 can be performed to assist in flushing additional Tamm-Horsfall and other non-exosomal or non-extracellular vesicle associated proteins through to the permeate. A range of wash fluids may be used including, but not limited to, alkaline Tris/EDTA diluent buffer, sterile water, buffered water, buffered water plus alternative chelators, surfactants, detergents, reducing agents, or other additives. Surfactants and detergents including polysorbates (e.g., Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

Other fluids and buffers that may be used include, but are not limited to RIPA buffer, HEPES buffered saline, Tris buffered saline, and phosphate-buffered saline. The concentrations of surfactants can be adjusted over a wide range to enhance or reduce disaggregation of Tamm-Horsfall proteins as desired and to reduce the potential of protein denaturation as required, as will be well understood by those skilled in the art. Further, any of these components and buffers may be used alone or in combination with each other or other similar components and buffers, as will be well understood by those skilled in the art.

Specifically recommended wash formulations with Tween 20 for improving recovery include, but are not limited to, alkaline Tris/EDTA diluent buffer plus 1% Tween 20, PBS plus 1% Tween 20, and Tris buffer plus 1% Tween 20. These wash formulations should be added into the filter apparatus at a volume equivalent to roughly ⅕^{th} of the urine sample volume. In this way a final Tween 20 concentration of 0.2% is achieved in the final filtered sample. A range of wash volumes from 1 mL to 100 mL or more preferred from 5 mL to 50 mL can be used. A Tween 20 concentration in the wash can be used from 0.01% to 10% or more preferred from 0.1% to 5%. A range of other formulations can be used that will enable improved recovery of exosomes and extracellular vesicles while not resulting in significant denaturing of associated proteins, as will be well understood by those skilled in the art.

Additional post-processing wash steps 207 may be performed as desired to remove additional contaminating materials, improve the buffer exchange, improve exosome recovery, or remove components introduced in the dilution fluid, prefilter wash steps, or the initial post-processing wash step 207. Formulations the same or similar to those recommended for use in the prefilter wash step can be used at the same or similar concentrations.

Immediately after the sample is processed, or after performing concentrating pipette wash steps, elution is performed using an elution fluid injection 208 and isolated, concentrated exosomes 209 are dispensed from the concentrating pipette tip. The elution can be performed using Applicant's current standard elution fluid formulation or custom or newly developed elution fluids. The current standard elution fluids are PBS/0.075% Tween 20 solution under a carbon dioxide head pressure of 125 psi nominal and 25 mM Tris/0.075% Tween 20, also under carbon dioxide head pressure. Alternative formulations include other buffer formulations along with alternative surfactants-used as foaming agents.

Surfactants and detergents that can be used as the foaming agent in the elution fluid includes polysorbates (e.g. Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

In addition to carbon dioxide other gases can be used to produce the foam. Nitrous oxide is highly soluble like carbon dioxide and makes an excellent elution fluid, but other less soluble gases can also be added to the formulation, including nitrogen and other inert gases.

The described method for isolating urinary exosomes using dilution, prefiltration, concentration, and elution steps provides an improved approach for obtaining isolated and concentrated exosomes from urine samples. The method addresses the limitations of existing techniques and offers enhanced efficiency and convenience for exosome isolation and downstream applications. While the above description contains specific details for the implementation of the method, it should be understood that variations and modifications can be made within the scope of the subject disclosure. These modifications can be made to further improve the workflow or isolation efficiencies but may also be made to isolate other targets including extracellular vesicles, microvesicles, and apoptotic bodies, for instance.

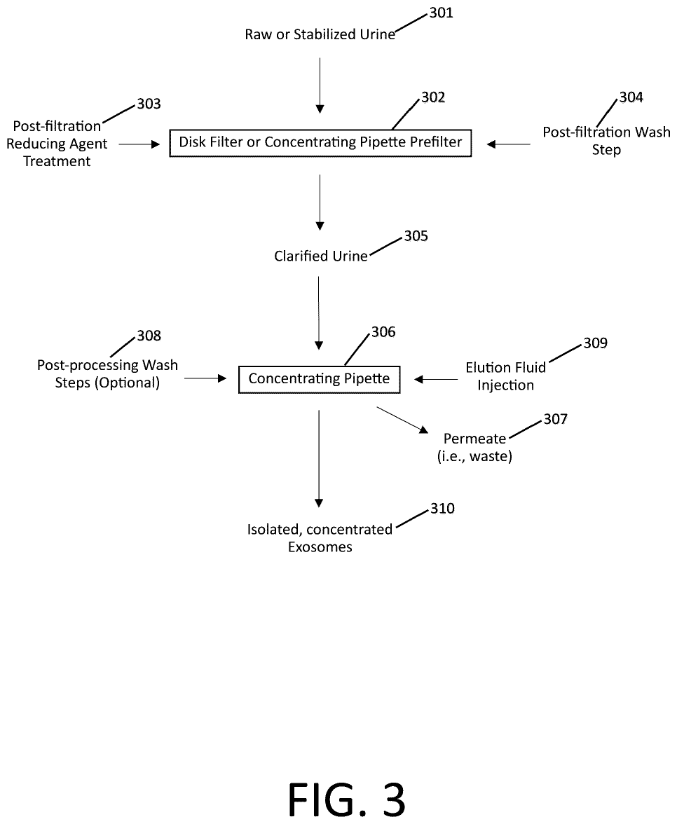

FIG. 3 shows a method similar to the method described in FIG. 2, but wherein a reducing agent treatment is performed prior to a post filtration wash step. In this case, the raw or stabilized urine sample 301 is processed using a disk filter or concentrating pipette prefilter 302 and when complete the prefiltration assembly vacuum is released and a post-filtration reducing agent treatment 303 is performed. A reducing agent is added onto the top side of the prefilter. The reducing agent is left in contact for an incubation period. Generally, the incubation period will range from 10 seconds to 20 minutes, but more preferrable from 30 seconds up to 5 minutes prior to processing by prefiltration. The reduction of THP can be achieved using reducing agents such as dithiothreitol (DTT), β-mercaptoethanol (β-ME), triethanolamine, CHAPS, urea, and other reducing agents that will be well known to those skilled in the art. Further, reducing agents may be used by themselves in water or buffer or in combination with other reducing agents, detergents, surfactants, or other additives. These reducing agents donate electrons to the disulfide bonds, resulting in the cleavage of the bonds and the generation of sulfhydryl groups. The reducing agent buffers may be used at room temperature or at an elevated temperature from 25° to 65° C. or more preferably from 30° C. to 40° C.

Immediately after the reducing agent has been drawn through the prefilter an optional post-filtration wash step 304 may be performed to improve exosome recovery from the material on the prefilter. Additionally, the wash step can include a surfactant, such as Tween 20, for instance, which is able to neutralize the effects of the reducing agents by forming micelles with and around the reducing agent—as in the same way that Tween 20 neutralizes SDS. Alternatively, the wash step can use the same fluid as the first wash step or may include additional reducing agents, or may be a clean buffer such as PBS, Tris, or clean water.

Additionally, following the reducing agent step, the use of an alkaline wash step may be used to further improve removal of exosomes from Tamm-Horsfall complexes. The alkaline wash may include from 50 mM to 250 mM of Na₂CO₃ with a pH between 9.0 and 11.5. More specifically, a 100 mM to 200 mM of Na₂CO₃ with a pH between 10.5 and 11.5, may be used. Other alkaline wash formulations may be used as will be well understood by those skilled in the art.

Additional wash steps can also be performed and then the clarified urine 305 sample can be processed by concentrating pipette 306 following the same, or similar, methods to those described for FIG. 1 and FIG. 2. During processing permeate 307 is dispensed to a waste container. After processing, post-processing wash steps 308, can be performed, and elution fluid injection 309 is performed and isolated, concentrate exosomes 310 are dispensed from the concentrating pipette tip into a small, concentrated volume.

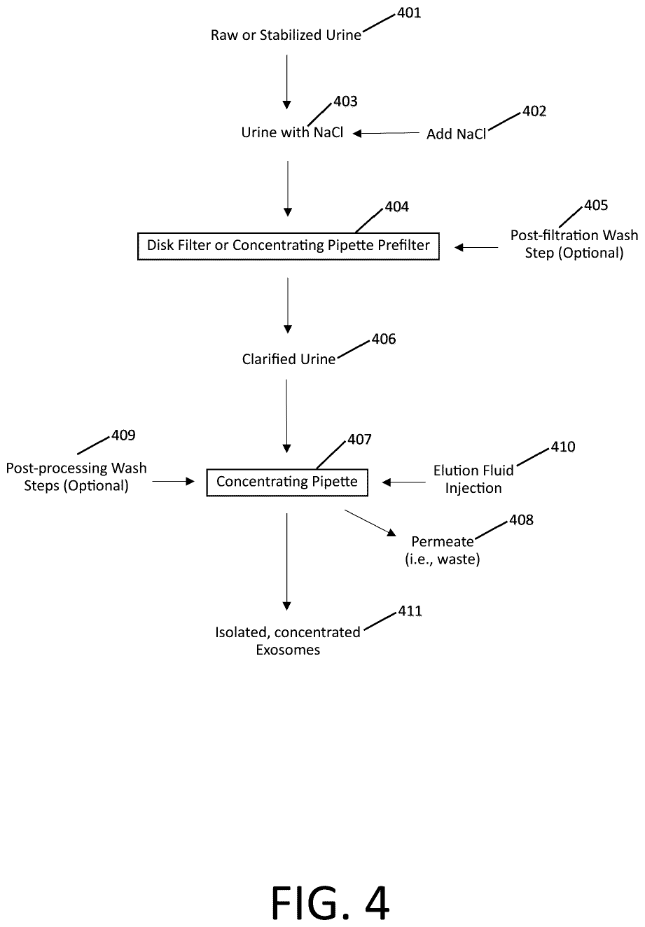

FIG. 4 shows a flow chart of a workflow for isolation and concentration of exosomes from raw or stabilized urine 401 using a Tamm-Horsfall protein salt precipitation method, followed by prefiltration, and then by further isolation and concentration using the Applicant Concentrating Pipette, according to an exemplary embodiment of the present subject disclosure. The workflow is optimized for isolation and concentration of exosomes, but may be used for isolation and concentration of other biological particles, with some modifications to the workflow, including extracellular vesicles, microvesicles, and apoptotic bodies, as will be understood by those skilled in the art.

The workflow enables the isolation and concentration of exosomes from urine samples while minimizing interference from larger Tamm-Horsfall protein complexes, other non-exosome and non-extracellular vesicle associated proteins including albumin, and cells and cell debris. The method is designed to be user friendly with minimal steps in its simplest form, but optional wash steps can also be performed to further improve upon the efficiency of exosome isolation and concentration or to further improve upon the Tamm-Horsfall protein or albumin removal efficiency.

This approach provides improved removal of Tamm-Horsfall protein but can result in higher losses of exosomes or extracellular vesicles. Incorporation of wash steps, especially with surfactants, can be performed to improve the exosome and extracellular vesicle recoveries.

As shown in FIG. 4, raw or previously stabilized urine 401 is first treated by adding sodium chloride (NaCl 402) or a concentrated NaCl solution to produce a 0.58 M NaCl concentration in the urine sample. The NaCl 402 addition initiates precipitation of Tamm-Horsfall proteins. Following addition of the NaCl 402 the sample is mixed to fully mix the added NaCl solution or to fully dissolve the added NaCl 402. An incubation period from 5 minutes to 3 hours is then performed at room temperature or 4° C. More preferably, the incubation period is between 20 min and 2 hours.

While the use of salt precipitation has been previously described for use in removal of Tamm-Horsfall protein from urine samples during extracellular vesicle isolation, the previously disclosed methods have utilized a multi-step centrifugation and filtration processes. This previously described workflow is complex and still does not sufficiently remove Tamm-Horsfall protein or recovery isolated exosomes or extracellular vesicles with sufficient efficiency. Each additional treatment step results in additional exosome loss to surfaces and material in the sample and also increases labor requirements and cost, and can increase the potential for technician error.

The described workflow overcomes these issues by using a single, post precipitation, filtration step to remove large cells and Tamm-Horsfall proteins, by relying upon either very large prefilter surface areas or graded depth filtration, or a combination of the two. For clarity, depth filtration refers to the use of a depth filter, which is most generally a fiber filter that captures particles throughout the thickness of the fiber rather than on the surface, as a membrane filter generally does. Graded depth filtration uses a graded depth filter, which is a fiber filter with a coarser more open structure on one side which transitions toward a tighter structure on the other side.

With graded depth filters the flow most commonly proceeds from the coarser, more open side, towards the tighter side. In this way, the filter is able to hold larger quantities of material within the structure without building up a fouling, gel layer as commonly occurs during filtration of proteinaceous fluids through a membrane filter.

By using these approaches, a single prefiltration step is required before isolation and concentration and the prefilter is much less susceptible to surface fouling which can lead to exosome losses. Further, the large surface area or graded depth filtration enable selection of tighter filter pore sizes which improve capture of the Tamm-Horsfall proteins while still allowing exosomes to pass through.

Prefiltration to remove Tamm-Horsfall protein and protein aggregates and complexes as well as cells, while allowing exosomes to pass is preferably performed using a fiber filter prefilter followed by a membrane filter. In this way, the fiber filter is able to hold a significant mass of non-exosomal material without creating a gel layer as would be created on a small surface area membrane filter. When using only a small diameter membrane filter the buildup of a gel layer results in fouling and entrapment of exosomes resulting in significant losses of exosomes.

Appropriate fiber filters for use in this application may be made from glass fiber, quartz fiber, cellulose fiber, polypropylene, PTFE, polyamide or nylon, polyester and other natural or synthetic materials as will be well understood by those skilled in the art. A fiber filter pore size range from 0.1 μm to 25 μm is recommend with a more preferred range of fiber filter pore sizes from 0.2 μm to 5.0 μm. In this way, the fiber filter is able to retain larger particles, including Tamm-Horsfall protein complexes and cells, but provides a torturous path in which the protein complexes can be captured rather than building up a fouling layer on the surface of the filter.

Additionally, graded fiber filters, which have a larger pore size on the first surface contacted by the fluid and a smaller pore size on the last surface contacted by the fluid, are advantageous. Similarly, two or more fiber filters may be stacked to provide a graded filter. When using graded fiber filters on top of a membrane filter, the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm.

Appropriate membrane filters for use as a final stage prefiltration in this application may be manufactured from various polymers, including but not limited to polyethersulfone (PES), polyvinylidene fluoride (PVDF), polytetrafluoroethylene (PTFE), nylon, cellulose acetate, cellulose ester, polycarbonate, polypropylene, and other natural or synthetic materials as will be well understood by those skilled in the art. A membrane filter pore size range from 0.05 μm to 5 μm is recommended with a more preferred range of fiber filter pore sizes from 0.1 μm to 0.8 μm. In this way, the fiber filter is able to retain larger particles, including Tamm-Horsfall protein complexes and cells, but is able to pass exosomes efficiently. Further the membrane filter pore size may be selected for passage of extracellular vesicles, microvesicles, and apoptotic bodies.

Based on the range of concentrations of Tamm-Horsfall protein in urine, a large membrane surface area must be used to further ensure that a significant fouling, gel layer does not build up on the membrane surface and cause losses of exosomes. For this reason, a membrane filter diameter ranging from 37 mm to 150 mm is recommended, with a more preferred diameter range from 47 mm to 125 mm. Further, when using smaller diameter membrane filters in the 37 mm to 110 mm range a thicker and tighter fiber filter should be used to allow for capture of Tamm-Horsfall protein complexes throughout the fiber filter matrix and thus a reduction of the gel fouling layer. Additionally, pleated membrane filters or hollow fiber membrane filters may be utilized to condense a larger surface area into a small device as will be well understood by those skilled in the art.

Alternatively, to the combined large membrane filter surface area and fiber filter prefilter, a thicker and tighter graded fiber prefilter may be utilized to perform the prefiltration step. In this case, the larger surface area of the described membrane filter is replaced with a thicker and tighter fiber filter that enables the Tamm-Horsfall complexes to be captured throughout the filter matrix and therefore not build up a fouling gel layer. One specific example of this type of approach is the Applicant concentrating pipette tip prefilter which uses a graded 0.9 μm glass fiber filter with a nominal thickness of 5 mm and a nominal surface area of 18 cm². With this filter the first contacted surface has a significantly larger pore size than the last contacted surface which enables deposition of the protein complexes throughout the matrix.

In the case of a graded fiber filter used alone without a membrane filter, the total internal volume of the filter (thickness in centimeters times the surface area in cm²) should range from 4 cm³ to 60 cm³ or more preferably from 5 cm³ to 50 cm³. Further, for the graded fiber filter the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm. These specifications allow for capture of the Tamm-Horsfall proteins throughout the internal filter volume while enabling efficient pass of exosomes. Further the filter pore size may be selected for passage of extracellular vesicles, microvesicles, and apoptotic bodies.

Alternatively, if a non-graded fiber filter is used alone without a membrane filter, the total internal volume of the filter (thickness in centimeters times the surface area in cm²) should range from 4 cm³ to 60 cm³ or more preferably from 5 cm³ to 50 cm³. Further, for the graded fiber filter the first contacted surface will have a recommended pore size range from 0.5 μm to 25 μm with a more preferred range of fiber filter pore sizes from 1.0 μm to 10 μm. In this case, the last contacted surface will have a recommended pore size range from 0.1 μm to 10 μm with a more preferred range of fiber filter pore sizes from 0.2 μm to 5 μm. These specifications allow for capture of the Tamm-Horsfall proteins throughout the internal filter volume while enabling efficient pass of exosomes. Further the filter pore size may be selected for passage of extracellular vesicles, microvesicles, and apoptotic bodies.

Following the incubation period the urine sample plus NaCl processed using a disk filter or concentrating pipette prefilter 404. The urine with NaCL 403 is poured into the prefiltration device, such as a Stericup Quick Release-HV Sterile Vacuum Filtration System—Millipore item #S2GPU01RE, 150 mL capacity, sterile, 0.22 μm pore size polyethersulfone (73 mm, 40 cm² surface area) with a glass fiber prefilter on top of the Stericup filter to reduce filter fouling and exosome losses. This prefiltration device is shown in FIG. 5. One possible prefilter that can be used with the described Stericup item #S2GPU01RE is Millipore item #AP2007500, 2.0 μm pore size, hydrophilic glass fiber filter with binder resin, 75 mm diameter, shown in FIG. 6, or Millipore item #AP1507500 1.0 μm pore size, hydrophilic glass fiber filter with binder resin, 75 mm diameter.

After pouring the sample into the prefiltration device, gentle pressure, vacuum, or gravity flow can be used to drive the liquid through the membrane. In the case of the described Stericup devices, it is recommended to apply roughly 1 atmosphere of negative pressure to the filter device, so that a high flow rate of liquid is created through the membrane filter. Using higher negative pressure, rather than low negative pressure or gravity flow, enables a higher flow rate of liquid through the membrane filter and acts to flush exosomes trapped within Tamm-Horsfall complexes out and into the filter permeate.

After filtering the urine sample an optional post-filtration wash step 405 may be performed to further improve recovery of exosomes or extracellular vesicles from the sample. A range of wash buffers may be used including, but not limited to, alkaline Tris/EDTA buffer, sterile water, buffered water, buffered water plus alternative chelators, surfactants, detergents, reducing agents, or other additives. Surfactants and detergents including polysorbates (e.g., Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

Other fluids and buffers that may be used include, but are not limited to RIPA buffer, HEPES buffered saline, Tris buffered saline, and phosphate-buffered saline. The concentrations of surfactants can be adjusted over a wide range to enhance or reduce disaggregation of Tamm-Horsfall proteins as desired and to reduce the potential of protein denaturation as required, as will be well understood by those skilled in the art. Further, any of these components and buffers may be used alone or in combination with each other or other similar components and buffers, as will be well understood by those skilled in the art.

Specifically recommended wash formulations with Tween 20 for improving recovery include, but are not limited to, alkaline Tris/EDTA buffer plus 1% Tween 20, PBS plus 1% Tween 20, and Tris buffer plus 1% Tween 20. These wash formulations should be added into the filter apparatus at a volume equivalent to roughly ⅕^{th} of the urine sample volume. In this way a final Tween 20 concentration of 0.2% is achieved in the final filtered sample. A range of wash volumes from 1 mL to 100 mL or more preferred from 5 mL to 50 mL can be used. A Tween 20 concentration in the wash can be used from 0.01% to 10% or more preferred from 0.1% to 5%. A range of other formulations can be used that will enable improved recovery of exosomes and extracellular vesicles while not resulting in significant denaturing of associated proteins, as will be well understood by those skilled in the art.

To perform the post-filtration wash step 405 the wash fluid is added to the top of the prefilter and is either drawn through using gentle pressure, vacuum, or gravity flow. The wash fluid may also be left on the prefilter with no vacuum or pressure applied to the filter apparatus. The wash fluid is left in place for a short incubation period ranging from 10 seconds to 10 minutes or more preferably from 30 seconds to 5 minutes, after which negative pressure is applied to the assembly to quickly draw the wash fluid through and into the same container holding the filtered urine sample.

If desired additional post-filtration wash steps 405 may be performed to further improve the exosome or extracellular vesicle recovery. The user then removes the filtrate sample container, which contains the filtered urine sample plus fluid from any wash steps performed. This filtered sample now contains smaller particles, including exosomes and other target particles, while the retained larger complexes and cells remain on the filter.

After prefiltration of the urine sample, and any wash steps performed, is complete the the clarified urine 405 is concentrated using the concentrating pipette 407 using Ultrafilter or 0.05 μm pore size concentrating pipette tips. The sample can be aspirated directly from the prefilter assembly sample container or transferred to another container before processing. Surfactant additions or reducing agents may also be added to the sample prior to processing with the concentrating pipette instrument if additional solubilization of the Tamm-Horsfall proteins is desired, so that removal of the protein can be enhanced.

The concentrating pipette instrument is operated using standard operational instructions for the instrument. The clarified urine 406 sample is placed on the instrument sample tray, the instrument arm and fluidics head are then raised. A concentrating pipette tip is attached to the head by the user via an interface. The arm is then lowered so that the concentrating pipette tip is submerged in the sample. The user then starts the concentrating unit by inputting commands via a user interface, and the sample is aspirated into the concentrating pipette tip and begins passing through the hollow fiber membrane filters in tip and permeate 408 is dispensed to waste. When the entire sample has been processed the user is alerted that the sample has been processed. The user may then choose to elute the sample or perform a post-processing wash step 409.

One more post-processing wash steps 409 can be performed to assist in flushing additional Tamm-Horsfall and other non-exosomal or non-extracellular vesicle associated proteins through to the permeate. A range of wash fluids may be used including, but not limited to, alkaline Tris/EDTA buffer, sterile water, buffered water, buffered water plus alternative chelators, surfactants, detergents, reducing agents, or other additives. Surfactants and detergents including polysorbates (e.g. Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art. Reducing agents include dithiothreitol (DTT), β-mercaptoethanol (β-ME), triethanolamine, CHAPS, and urea for example, but many other reducing agents may be used individually or in combination as will be well understood by those skilled in the art.

Other fluids and buffers that may be used include, but are not limited to RIPA buffer, HEPES buffered saline, Tris buffered saline, and phosphate-buffered saline. The concentrations of surfactants can be adjusted over a wide range to enhance or reduce disaggregation of Tamm-Horsfall proteins as desired and to reduce the potential of protein denaturation as required, as will be well understood by those skilled in the art. Further, any of these components and buffers may be used alone or in combination with each other or other similar components and buffers, as will be well understood by those skilled in the art.

Specifically recommended wash formulations with Tween 20 for improving recovery include, but are not limited to, alkaline Tris/EDTA buffer plus 1% Tween 20, PBS plus 1% Tween 20, and Tris buffer plus 1% Tween 20. These wash formulations should be added into the filter apparatus at a volume equivalent to roughly ⅕^{th} of the urine sample volume. In this way a final Tween 20 concentration of 0.2% is achieved in the final filtered sample. A range of wash volumes from 1 mL to 100 mL or more preferred from 5 mL to 50 mL can be used. A Tween 20 concentration in the wash can be used from 0.01% to 10% or more preferred from 0.1% to 5%. A range of other formulations can be used that will enable improved recovery of exosomes and extracellular vesicles while not resulting in significant denaturing of associated proteins, as will be well understood by those skilled in the art.

Additional wash steps may be performed as desired to remove additional contaminating materials, improve the buffer exchange, improve exosome recovery, or remove components introduced in the precipitation fluid, prefilter wash steps, or the initial concentrating pipette wash step. Formulations the same or similar to those recommended for use in the prefilter wash step can be used at the same or similar concentrations.

Specifically, the use of an alkaline wash step may be used to further improve removal of Tamm-Horsfall and other proteins prior to elution. The alkaline wash may include from 50 mM to 250 mM of Na₂CO₃ with a pH between 9.0 and 11.5. More specifically, a 100 mM to 200 mM of Na₂CO₃ with a pH between 10.5 and 11.5, may be used. A 25 mM Tris/1 mM EDTA solution with a pH between 9 and 11 may be used as a wash fluid as well. The tris concentration of this fluid may range from 5 mM to 1 M or more preferably from 10 mM to 50 mM. The EDTA concentration may range from 0.1 mM to 1 M or more preferably from 0.25 mM to 10 mM. Other alkaline wash formulations may be used as will be well understood by those skilled in the art.

Immediately after the clarified urine 406 sample is processed, or after performing post-processing wash steps 409, the elution can be performed. The elution can be performed by elution fluid injection 410 using Applicant's current standard elution fluid formulation or custom or newly developed elution fluids. The current standard elution fluids are PBS/0.075% Tween 20 solution under a carbon dioxide head pressure of 125 psi nominal and 25 mM Tris/0.075% Tween 20, also under carbon dioxide head pressure. Alternative formulations include other buffer formulations along with alternative surfactants-used as foaming agents.

Surfactants and detergents that can be used as the foaming agent in the elution fluid includes polysorbates (e.g. Tween 20 and Tween 80), Triton X-100 and other Triton surfactants, CHAPS, Brij surfactants, CTAB, SDS, Saponin, Span surfactants, poloxamers and Pluronics, and a range of other surfactants and detergents that will be well known to those skilled in the art.

In addition to carbon dioxide other gases can be used to produce the foam. Nitrous oxide is highly soluble like carbon dioxide and makes an excellent elution fluid, but other less soluble gases can also be added to the formulation, including nitrogen and other inert gases.

After elution fluid injection 410, isolated, concentrated exosomes 411 are dispensed into a small volume of elution fluid buffer. The described method for isolating urinary exosomes using salt precipitation, prefiltration, concentration, and elution steps provides an improved approach for obtaining isolated and concentrated exosomes from urine samples. The method addresses the limitations of existing techniques and offers enhanced efficiency and convenience for exosome isolation and downstream applications. While the above description contains specific details for the implementation of the method, it should be understood that variations and modifications can be made within the scope of the subject disclosure. These modifications can be made to further improve the workflow or isolation efficiencies but may also be made to isolate other targets including extracellular vesicles, microvesicles, and apoptotic bodies, for instance.

FIG. 5 shows one possible prefiltration device that can be used in the methods described in FIG. 1, FIG. 2, FIG. 3, and FIG. 4. The prefilter device 500, is made up of filter 501, fluid reservoir 502, connector 503, filtered sample bottle 504, and connector 505 with opening 506. To operate the device a urine sample, clarified urine sample, or otherwise treated urine sample is poured into fluid reservoir 502 and a hose connected to a vacuum source is connected to connector 505 with opening 506. The vacuum is then turned on and a vacuum is pulled on filtered sample bottle 504 causing the urine sample to flow through filter 501 and into sample bottle 504.

Filter 501 may be made of any number of membrane filter, fiber filter, or other filter types as will be well known to those skilled in the art. One possible device of this type is the commercially available Stericup Quick Release-HV Sterile Vacuum Filtration System-Millipore item #S2GPU01RE, 150 mL capacity, sterile, 0.22 μm pore size polyethersulfone (73 mm, 40 cm² surface area). This device can be used alone or in combination with a fiber prefilter to reduce gel layer formation. Other similar devices may also be used, as appreciated by one having ordinary skill in the art after consideration of the present subject disclosure.

FIG. 6 shows one possible fiber prefilter that can be used in combination with the device shown in FIG. 5. The fiber prefilter is Millipore item #AP2007500, 2.0 μm pore size, hydrophilic glass fiber filter with binder resin, 75 mm diameter. One alternative to this device is Millipore item #AP1507500 1.0 μm pore size, hydrophilic glass fiber filter with binder resin, 75 mm diameter. Other similar filters may also be used, as appreciated by one having ordinary skill in the art after consideration of the present subject disclosure.

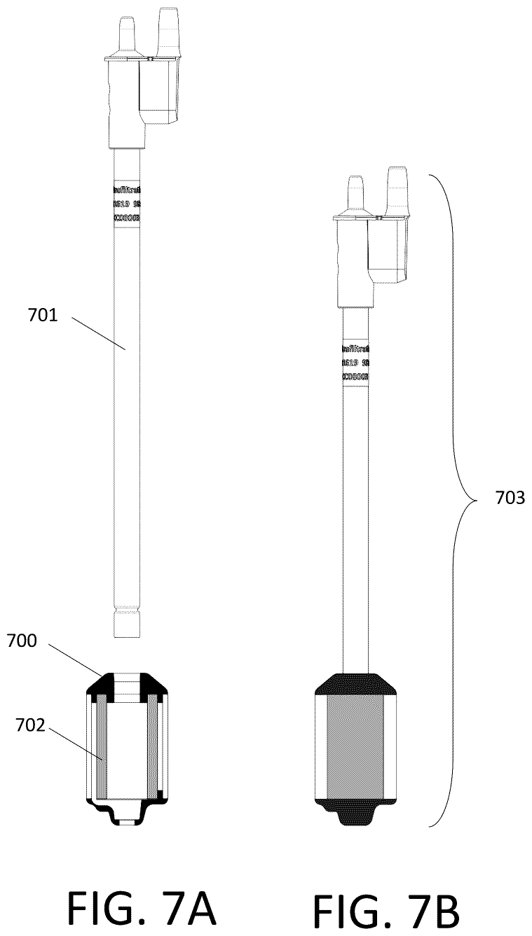

FIGS. 7A and 7B show two views of a previously described concentrating pipette tip prefilter for use with the described methods. See patents and application incorporated by reference. 700 shows the prefilter assembly, 701 shows the concentrating pipette tip, 702 shows the fiber filter element within the prefilter assembly, and 703 shows the assembled concentrating pipette tip and prefilter.

Fiber filter element 702 is preferably a graded fiber filter element wherein the first surface contacted is coarser and the final surface contacted is tighter. In this way formation of a gel layer or fouling layer is minimized and the Tamm-Horsfall protein and protein complexes, cells, and cellular debris are captured throughout the depth of the filter. This assembly can be used in place of the membrane filter assemblies described elsewhere in this application.

Appropriate fiber filters for use in this device may be made from glass fiber, quartz fiber, cellulose fiber, polypropylene, PTFE, polyamide or nylon, polyester and other natural or synthetic materials as will be well understood by those skilled in the art. A fiber filter pore size range from 0.1 μm to 25 μm is recommend with a more preferred range of fiber filter pore sizes from 0.2 μm to 1.0 μm. In this way, the fiber filter is able to retain larger particles, including Tamm-Horsfall protein complexes and cells, but provides a torturous path in which the protein complexes can be captured rather than building up a fouling layer on the surface of the filter.

Following processing of urine or other biological fluid samples, using the methods described herein, samples may be subsequently processed using secondary exosome or extracellular processing methods including, but not limited to size-exclusion chromatography, centrifugation, density-gradient centrifugation, ultracentrifugation, hydrostatic dialysis, precipitation, two-phase isolation, binding methods, and microfluidic approaches. More specifically, highly selective methods such as size-exclusion chromatography and binding methods, including antibody, lectin, heparin-modified, phosphatidylserine-binding, and other bead and non-bead based binding methods, can provide excellent secondary isolation of exosomes and extracellular vesicles following isolation using the methods described herein.

The methods and techniques described herein have a limitless applicability in various fields, as appreciated by one having ordinary skill in the art. In one use, the method may be used for the isolation and concentration of environmental exosomes as well. For example, as all animals excrete and/or shed exosomes, which would end up in wastewater or runoff and natural waters, which can then be monitored for community levels of cancer, heart disease, neurological disorders, etc.

Specific animal exosomes may be monitored as well. For example, fish excrete exosomes. One example, zebrafish, are widely used in diagnostics and drug development. One of the many uses of the present method could be to consider zebrafish exosomes as indicators of health of the laboratory zebrafish population, especially when there are numerous zebrafish in a given area, which could be in the hundreds of thousands. Monitoring environmental exosomes in natural waters will have countless positive outcomes and gain understanding into the heath of the fish population and environment in which they live.

These are merely non-limiting examples, and the countless examples of uses would be evident to one having ordinary skill in the art after consideration of the present disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A method, comprising:
diluting a raw or stabilized urine sample with a dilution fluid to produce a diluted urine sample;
flowing the diluted urine sample through a prefilter to remove large cells, cellular debris, protein, and protein complexes while passing extracellular vesicles therethrough;
processing of the prefiltered, diluted urine sample using a concentrating pipette tip and a concentrating pipette instrument;
capturing extracellular vesicles and passing other particles and molecules through to a permeate; and
eluting the captured extracellular vesicles into a concentrated volume.

2. The method in claim 1, wherein the dilution fluid contains an alkaline, buffered solution containing a chelator.

3. The method in claim 1, wherein the dilution fluid contains Tris buffer and Ethylenediaminetetraacetic acid with an adjusted pH between 8.5 and 10.0.

4. The method in claim 1, wherein the dilution fluid contains a surfactant.

5. The method in claim 1, wherein the dilution fluid contains a reducing agent.

6. The method in claim 1, wherein the dilution fluid is added to create a urine: buffer ratio of 1:2 to 1:6.

7. The method of claim 6, wherein following addition of the dilution fluid, the diluted urine sample is mixed by inversion, stirring, or vortexing.

8. The method of claim 7, wherein the diluted urine sample is incubated to enhance disaggregation of proteins.

9. The method of claim 8, wherein the diluted urine sample is incubated for 1 minute to 5 minutes.

10. The method of claim 1, wherein flowing the diluted urine sample through the prefilter includes the use of one or both of a prefilter surface area and/or graded depth filter.

11. The method of claim 10, wherein the graded depth filter includes a fiber filter with a more coarser and open structure on an upstream side, and transitions toward a tighter structure on a downstream side.

12. The method of claim 11, wherein the fiber filter has a membrane fiber filter pore sizes ranging from 0.1 μm to 0.8 μm.

13. The method of claim 10, further adding a wash step using a wash buffer after the step of flowing the diluted urine sample through the prefilter.

14. The method of claim 13, further adding a reducing agent treatment prior to the wash step.

15. The method of claim 1, further comprising adding an elution fluid to the processing step.

16. The method of claim 15, wherein adding the elution fluid to the processing step results in formation of a permeate which is separated from the captured extracellular vesicles.

17. The method of claim 16, wherein the captured extracellular vesicles comprise exosomes.

18. The method of claim 1, wherein the raw or stabilized urine is first treated by adding sodium chloride or a concentrated NaCl solution.

19. The method of claim 18, wherein adding sodium chloride or a concentrated NaCl solution produces a 0.58 M NaCl concentration in the urine sample.

20. A method, comprising:
processing a diluted urine sample using a concentrating pipette prefilter, concentrating pipette tip and concentrating pipette instrument;
capturing extracellular vesicles and passing other particles and molecules through to a permeate; and
eluting the captured extracellular vesicles into a small concentrated volume.
